(19) United States
(12) Patent Application Publication
(10) Pub. No.: US 2018/0336812 A1
(43) Pub. Date: Nov. 22, 2018

(54) IMAGE DISPLAY APPARATUS, LIQUID CRYSTAL DISPLAY METHOD, AND LIQUID CRYSTAL DISPLAY PROGRAM

(71) Applicant: CANON KABUSHIKI KAISHA, Tokyo (JP)

(72) Inventors: Nobuhiro Oka, Yokohama-shi (JP); Ikunari Nakahara, Tokyo (JP)

(21) Appl. No.: 15/976,936

(22) Filed: May 11, 2018

(30) Foreign Application Priority Data
May 17, 2017 (JP) 2017-097775

(51) Int. Cl. G09G 3/20; G09G 3/34; G09G 3/36; G03B 21/00

(52) U.S. Cl. CPC G09G 3/2022; G09G 3/3406; G09G 2320/0247; G03B 21/006; G09G 2330/02; G09G 3/3611

(57) ABSTRACT

A liquid crystal display apparatus receives illumination light from a light source to a liquid crystal element, displays an image, and includes a gradation converter configured to generate a plurality of subframes by performing different gradation conversion processes for a plurality of input frames that are continuously input, a driver configured to drive the liquid crystal element by controlling an application period of a first voltage and an application period of a second voltage lower than the first voltage for each pixel in the liquid crystal element in accordance with gradation data for each subframe, and a controller configured to provide a light intensity control for each subframe so as to change an intensity of the illumination light or an intensity of display light from the liquid crystal element in accordance with the gradation conversion processing for generating the subframe.

### BACKGROUND OF THE INVENTION

### Field of the Invention

The present invention relates to an image display apparatus using a liquid crystal element driven by a digital driving method.

### Description of the Related Art

As a liquid crystal element, there are a transmission type liquid crystal element, such as a twisted nematic (TN) element, and a reflection type liquid crystal element, such as a vertical alignment nematic (VAN) element. A driving method of these liquid crystal element contains an analogue driving method for controlling the brightness by changing the voltage applied to a liquid crystal layer in accordance with the gradation, and a digital driving method for binarizing the voltage applied to the liquid crystal layer and for controlling the brightness by changing the voltage application period. One type of the digital driving method is a subfield driving method that divides one frame period into a plurality of subfield periods on a time axis, controls the application (turning on) and nonapplication (turning off) of the predetermined voltage to the pixel for each subfield, and displays the gradation on the pixels. The subfield driving method is also referred to as a subframe driving method.

Next follows a description of the general subfield driving method. FIG. 30 illustrates an example that divides one frame period into a plurality of subfield periods (bit lengths). A numerical value on each subfield represents a time weight on the subfield in one frame period. In an example, 64 gradations are expressed. In this description, a period of the time weight of 1+2+4+8+16 will be referred to as an A subfield period, and a period of the time weight of 32 will be referred to as a B subfield period. Moreover, a subfield period in which the above predetermined voltage is turned on will be referred to as an ON period, and a subfield period in which the above predetermined voltage is turned off will be referred to as an OFF period.

FIG. 31 illustrates all gradation data corresponding to the subfield division examples illustrated in FIG. 30. The ordinate axis represents a gradation, and the abscissa axis represents one frame period. In FIG. 31, a white subfield period represents the ON period for displaying the pixel in white, and a black subfield period represents the OFF period for displaying the pixel in black. According to this gradation data, in displaying two continuous gradations, such as a thirty-second gradation and a thirty-third gradation, on two adjacent pixels in the liquid crystal element, the A subfield period is set to the ON period for the thirty-second gradation and set to the OFF period for the thirty-third gradation. In addition, the B subfield period is set to the OFF period for the thirty-second gradation and set to the ON period for the thirty-third gradation.

When the ON period and the OFF period are thus concurrent with each other between two adjacent pixels or when a predetermined voltage is applied to one of the adjacent pixels and is not applied to the other of the adjacent pixels at the same time, a so-called disclination occurs and the brightness lowers in the ON pixel.

Japanese Patent Laid-Open No. (“JP”) 2013-050681 discloses a method for periodically changing a disclination position by adding a periodically changing correction value for each frame to all pixels in the liquid crystal element so that the observer is less likely to visually recognize the reduced brightness of the pixel caused by the disclination.

However, when the method disclosed in JP 2013-050681 is applied to displaying an image with a low frame rate, the correction value is not frequently changed and the periodically changing brightness or so-called flickers are likely to stand out.

### SUMMARY OF THE INVENTION

The present invention provides an image processing apparatus etc. which can restrain the brightness drop of the pixel caused by the disclination so that the flickers are less likely to stand out.

A liquid crystal display apparatus according to the present invention introduces illumination light from a light source to a liquid crystal element, displays an image, and includes a gradation converter configured to generate a plurality of subframes by performing different gradation conversion processes for a plurality of input frames that are continuously input, a driver configured to drive the liquid crystal element by controlling an application period of a first voltage and an application period of a second voltage lower than the first voltage for each pixel in the liquid crystal element in accordance with gradation data for each subframe, and a controller configured to provide a light intensity control for each subframe so as to change an intensity of the illumination light or an intensity of display light from the liquid crystal element in accordance with the gradation conversion processing for generating the subframe.

Further features of the present invention will become apparent from the following description of exemplary embodiments with reference to the attached drawings.

### BRIEF DESCRIPTION OF THE DRAWINGS

FIG. 1 illustrates a structure of a liquid crystal projector according to a first embodiment of the present invention.

FIG. 2 is a sectional view of a liquid crystal element used for the liquid crystal projector according to the first embodiment.

FIG. 3 illustrates a plurality of subfield periods in one frame according to the first embodiment.

FIG. 4 illustrates gradation data in an A subfield period according to the first embodiment.

FIG. 5 illustrates all gradation data according to the first embodiment.

FIG. 6 illustrates a pixel line according to the first embodiment.

FIG. 7 illustrates a liquid-crystal response characteristic when an all-white display is changed to a monochromatic display according to the first embodiment.

FIG. 8 illustrates a brightness response characteristic when the all-white display is changed to the monochromatic display according to the first embodiment.

FIG. 9 illustrates a liquid-crystal response characteristic when an all-black display is changed to the monochromatic display according to the first embodiment.

FIG. 10 illustrates a brightness response characteristic when the all-black display is changed to the monochromatic display according to the first embodiment.

FIG. 11 illustrates an internal structure in an image processor according to the first embodiment.

FIGS. 12A to 12C illustrate an internal structure of a gradation converter according to the first embodiment.

FIGS. 13A to 13C illustrate gain processing performed in the gradation converter according to the first embodiment.

FIG. 14A illustrates one example of a gradation updating timing in a liquid crystal element and a brightness changing timing in a light source according to the first embodiment.

FIG. 14B illustrates another example of a gradation updating timing in a liquid crystal element and a brightness changing timing in a light source according to the first embodiment.

FIG. 14C illustrates the gradation updating timing in the liquid crystal element and the constant brightness in the light source according to the first embodiment.

FIG. 15 is a flowchart of a processing sequence according to the first embodiment.

FIGS. 16A and 16B illustrate a gradation updating timing in a liquid crystal element and a brightness changing timing in a light source according to a second embodiment of the present invention.

FIG. 17 is a flowchart of a processing sequence according to the second embodiment.

FIG. 18 illustrates an internal structure in an image processor according to a third embodiment.

FIG. 19 illustrates an internal structure of a gradation converter according to the third embodiment.

FIG. 20 illustrates a gradation updating timing (based on an all-pixel updating method) in a liquid crystal element and a brightness changing timing in the light source according to the third embodiment.

FIG. 21 illustrates a gradation updating timing (based on a scan updating method) in the liquid crystal element and the brightness changing timing in the light source according to the third embodiment.

FIG. 22 illustrates a structure of a liquid crystal projector according to a fourth embodiment of the present invention.

FIG. 23 illustrates an internal structure in an image processor according to a fourth embodiment.

FIG. 24 illustrates an internal structure of a gradation converter according to the fourth embodiment.

FIGS. 25A to 25D illustrate gain processing performed in the gradation converter according to the fourth embodiment.

FIG. 26 illustrates a gain and a luminance modulation rate in a luminance modulation element according to the fourth embodiment.

FIG. 27 illustrates an example in which a liquid crystal element and a luminance modulation element have different resolutions.

FIG. 28 illustrates a processing sequence according to the fourth embodiment.

FIG. 29 is a flowchart of another processing sequence according to the fourth embodiment.

FIG. 30 illustrates a plurality of subfield periods in one frame in one frame in prior art.

FIG. 31 illustrates all gradation data in prior art.

FIG. 32 illustrates all gradation data in Japanese Patent Laid-Open No. 2013-050681.

FIG. 33 is a flowchart of another process sequence according the second embodiment.

FIG. 34 illustrates another example of a gradation updating timing in a liquid crystal element and a brightness changing timing in a light source according to the second embodiment.

### DESCRIPTION OF THE EMBODIMENTS

Referring now to the accompanying drawings, a description will be given of embodiments according to the present invention.

### First Embodiment

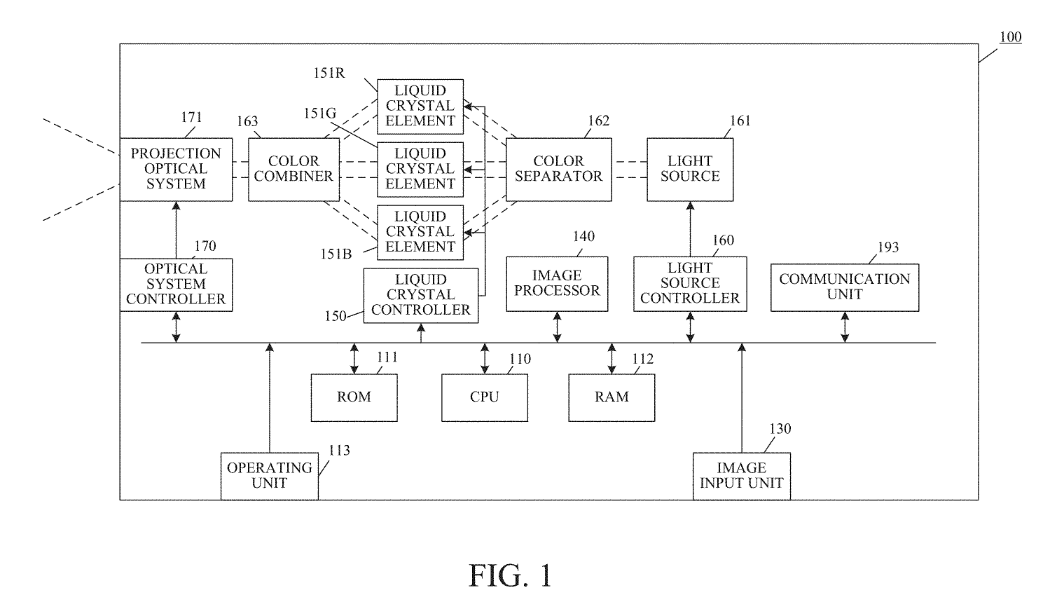

FIG. 1 is a configuration in a liquid crystal projector 100 as a liquid crystal apparatus according to a first embodiment of the present invention. The liquid crystal projector 100 includes a CPU 110, a ROM 111, a RAM 112, an operating unit 113, an image input unit 130, an image processor 140, a liquid crystal controller 150, liquid crystal elements 151 (151R, 151G, and 151B), a light source controller 160, a light source 161, a color separator 162, a color combiner 163, an optical system controller 170, and a projection optical system 171.

The CPU 110 controls all operations in the liquid crystal projector 100. The ROM 111 stores a computer program for use with controls and processing by the CPU 110. The RAM 112 serves as a working memory that temporarily stores the computer program and data.

The operating unit 113 accepts a command (operation) by a user, and sends an operation signal to the CPU 110. The operating unit 113 includes a switch, a dial, and a touch panel etc. provided to a display unit 196. The operating unit 113 includes a receiver that receives a remote control signal, such as an infrared signal, from a remote controller, and sends a command signal corresponding to the received remote control signal to the CPU 110. The CPU 110 receives an operation signal from the operating unit 113 and a control signal input from a communication unit 193, and controls each operation in the liquid crystal projector 100.

An image signal is input from an external unit to the image input unit 130. The external unit includes a personal computer, a digital camera, a smartphone, a hard disk recorder, a game machine, etc. The image processor 140 includes a microprocessor for providing various processing, such as changing the number of frames, the pixel number, and image shape etc. for the image signal received from the image input unit 130, and sends the processed image signal to the liquid crystal controller 150. The image processor 140 performs a frame decimation process, a frame interpolation process, a resolution conversion (scaling) process, and a distortion correction process (keystone correction process) etc. for the image signal.

The liquid crystal controller (driver) 150 includes a microprocessor for a liquid crystal control, adjusts a voltage applied to each pixel in the liquid crystal elements 151R, 151G, and 151B based on the image signal processed by the image processor 140, and thereby controls a transmittance or a reflectance of each pixel. In other words, the liquid crystal controller 150 drives the liquid crystal elements 151R, 151G, and 151B.

The light source 161 includes a light emission element, such as a laser, an LED, a halogen lamp, a xenon lamp, and a high-pressure mercury lamp. The light source 161 may include a fluorescent body that is excited by excitation light and emits fluorescent light. The light source controller 160 includes a microprocessor for a light source control, and controls turning on and off the light source 161 and a (light emission) luminance in the ON state in the light source 161. The luminance control corresponds to the light intensity control for changing the intensity of the light (illumination light) incident on the liquid crystal elements 151R. 151G, and 151B. The CPU 110 and the light source controller 160 constitute a controller.

The color separator 162 includes a dichroic mirror and a polarization beam splitter etc., splits white light as the illumination light from the light source 161 into red (R) light, green (G) light, and blue (B) light, and guides each colored light to a corresponding one of the liquid crystal elements 151R, 151G, and 151B. The liquid crystal element 151R modulates the red light by controlling the transmittance or reflectance of the red light for each pixel. The liquid crystal element 151G modulates the green light by controlling the transmittance or reflectance of the green light for each pixel. The liquid crystal element 151B modulates the blue light by controlling the transmittance or reflectance of the blue light for each pixel.

The color combiner 163 includes a polarization beam splitter, a color combining prism etc., combines the red light, the green light, and the blue light modulated by the liquid crystal elements 151R, 151G, and 151B, and guides the combined light to a projection optical system 171. The projection optical system 171 projects the combined light (display light) from the color combiner 163 onto a target surface, such as a screen, thereby displaying the colored image. The optical system controller 170 includes a microprocessor for an optical system control, and controls focusing, zooming etc. in the projection optical system 171.

Each of the image processor 140, the liquid crystal controller 150, the light source controller 160, and the optical system controller 170 does not have to include a dedicated microprocessor. For example, the CPU 110 that operates in accordance with the computer program stored in the ROM 111 may serve as the image processor 140, the light source controller 160, and the optical system controller 170.

The communication unit 193 receives image data, the control signal, etc. from the external apparatus and the remote controller through a communicator, such as a wireless or wired LAN, a USB, and a Bluetooth. The image input unit 130 may provide a CED communication via the terminal when the HDMI terminal is contained.

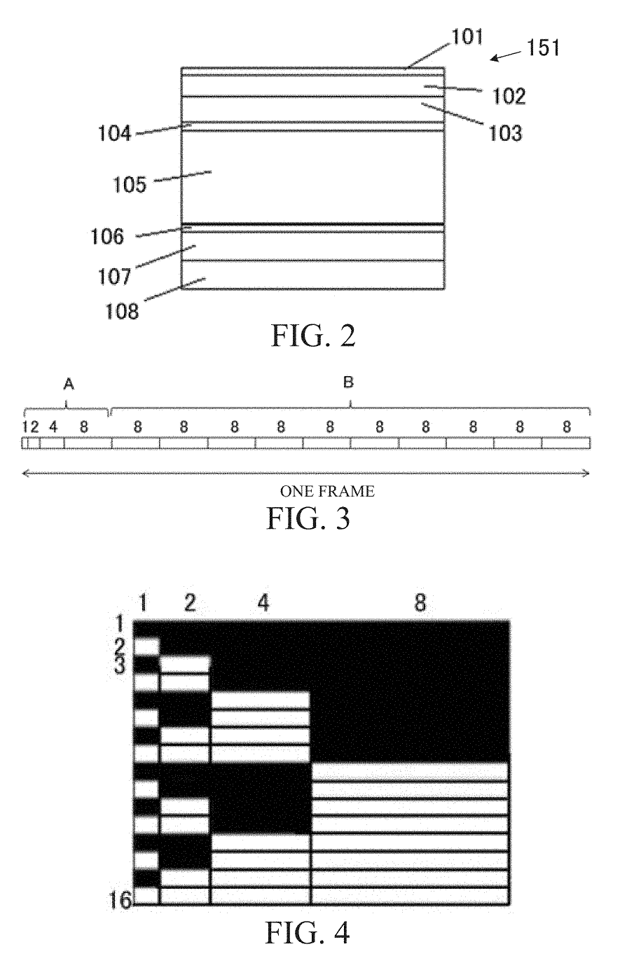

FIG. 2 illustrates a sectional structure of the liquid crystal element 151 (151R, 151G, and 151B). FIG. 2 illustrates the structure of the reflection type liquid crystal element. Reference numeral 101 denotes an antireflection (AR) coating film, reference numeral 102 denotes a glass substrate, reference numeral 103 denotes a common electrode, reference numeral 104 denotes an alignment film, reference numeral 105 denotes a liquid crystal layer, reference numeral 106 denotes an alignment film, reference numeral 107 denotes a pixel electrode, and reference numeral 108 denotes a Si substrate. The liquid crystal element 151 may be of a transmission type.

The liquid crystal controller 150 illustrated in FIG. 1 drives each pixel based on the above subfield driving method. This method divides one frame period into a plurality of subfield (subframe) periods on the time axis, controls turning on (applying) and turning off (nonapplying) the predetermined voltage to the pixel for each subfield period in accordance with the gradation data, and forms (displays) the gradation on the pixel. One frame period is a period for displaying a one-frame image data on the liquid crystal element. This embodiment drives the liquid crystal element at 120 Hz and sets the one frame period to 8.33 ms. Turning on and off the predetermined voltage may mean applying a first voltage (predetermined voltage) and applying a second voltage lower than the first voltage.

Next follows a description of the subfield period setup and the gradation data in the liquid crystal controller 150. The liquid crystal controller 150 may include a computer, and control setting of the subfield period and turning on and off the predetermined voltage for each subfield period in accordance with the liquid crystal driving program as the computer program.

FIG. 3 illustrates one frame period divided into a plurality of subfields (bit lengths) according to this embodiment. A numeral value on each subfield means a time weight on the subfield in one frame period. This embodiment expresses 96 gradations. This embodiment refers to a period for the time weight of 1+2+4+8 as an A subfield period (first period), and refers to a bit representative of a gradation binarized in the A subfield period as a low-order (or lower) bit. In addition, this embodiment refers to 10 subfields with the time weight of 8 as a B subfield period (second period), and refers to a bit representative of a gradation binarized in the B subfield period as a high-order (or upper) bit. The time weight of 1 corresponds to 0.087 ms, and the time weight of 8 corresponds to 0.69 ms.

In addition, the subfield period used to turn on the above predetermined voltage (or to apply the first voltage) will be referred to as an ON period, and the subfield period used to turn off the above predetermined voltage (or to apply the second voltage) will be referred to as an OFF period.

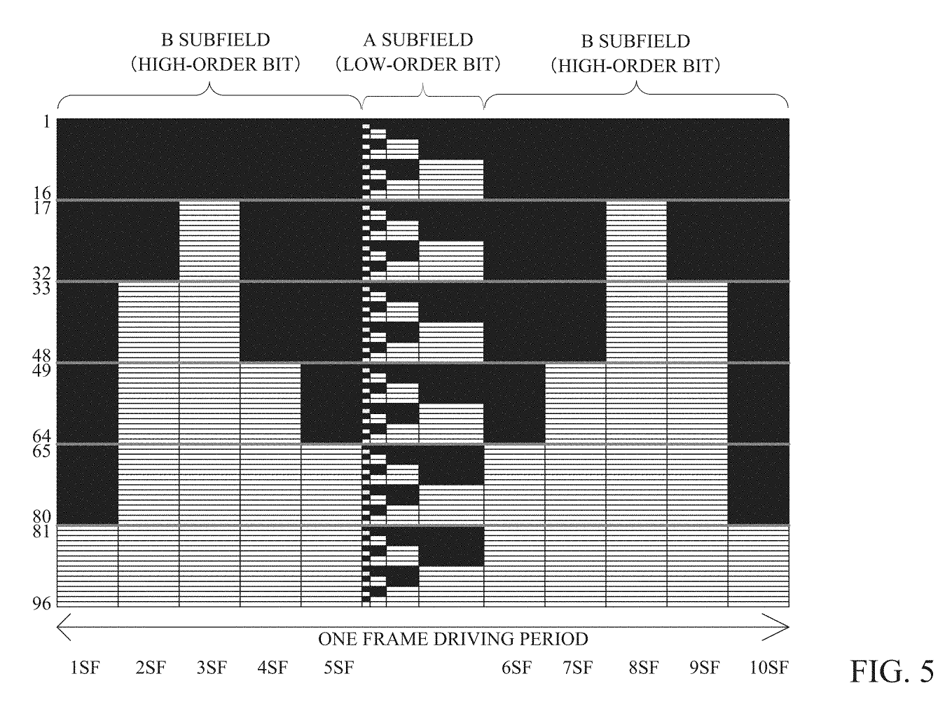

FIG. 4 illustrates gradation data in the A subfield period illustrated in FIG. 3. The ordinate axis denotes a gradation, and the abscissa axis denotes one frame period. The A subfield period expresses 16 gradations. In FIG. 4, a white subfield period represents the ON period in which the above predetermined voltage is applied so as to display the pixel in white, and a black subfield period represents the OFF period in which the above predetermined voltage is not applied so as to display the pixel in black.

FIG. 5 illustrates gradation data in the A and B subfield periods (low-order and high-order bits) according to this embodiment. This gradation data is used to express all 96 gradations. In this gradation data, the A subfield period (low-order bit) is disposed at the center of the one frame period, and the B subfield period (high-order bit) is divided into 1SF to 5SF and 6SF to 10SF and arranged before and after the A subfield period. In other words, the B subfield period is divided into two, and each B subfield period contains two or more subfield periods.

According to this gradation data, in order to display two adjacent gradations, such as 48^{th} and 49^{th} gradations, on two adjacent pixels in the liquid crystal element, the A subfield period is set to the ON period for the 48^{th} gradation and to the OFF period for the 49^{th} gradation. 1SF, 4SF, 5SF, 6SF, 7SF, and 10SF are set to the OFF period and 2SF, 3SF, 8SF and 9SF are set to the ON period for the 48^{th} gradation among the B subfield periods. On the other hand, 1SF, 5SF, 6SF, and 10SF are set to the OFF period and 2SF, 3SF, 4SF, 7SF, 8SF and 9SF are set to the ON period for the 49^{th} gradation among the B subfield periods. In order to display these adjacent gradations on adjacent pixels, ON/OFF adjacent periods occur in which the ON period and the OFF period are concurrent with each other between the adjacent pixels. More specifically, in order to display the 48^{th} and 49^{th} gradations on the adjacent pixels, 4SF and 7SF among the B subfield periods are the ON/OFF adjacent periods.

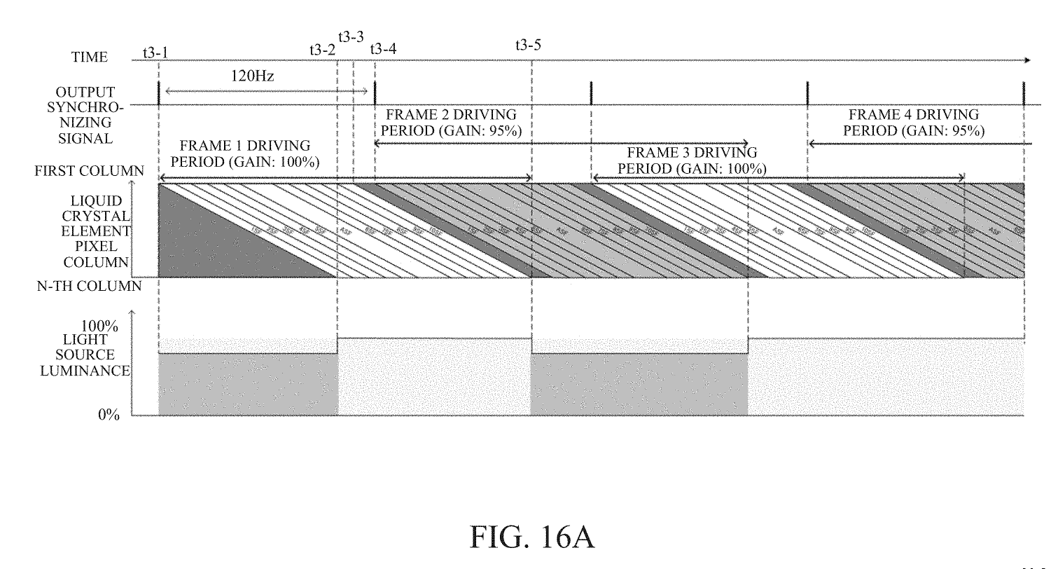

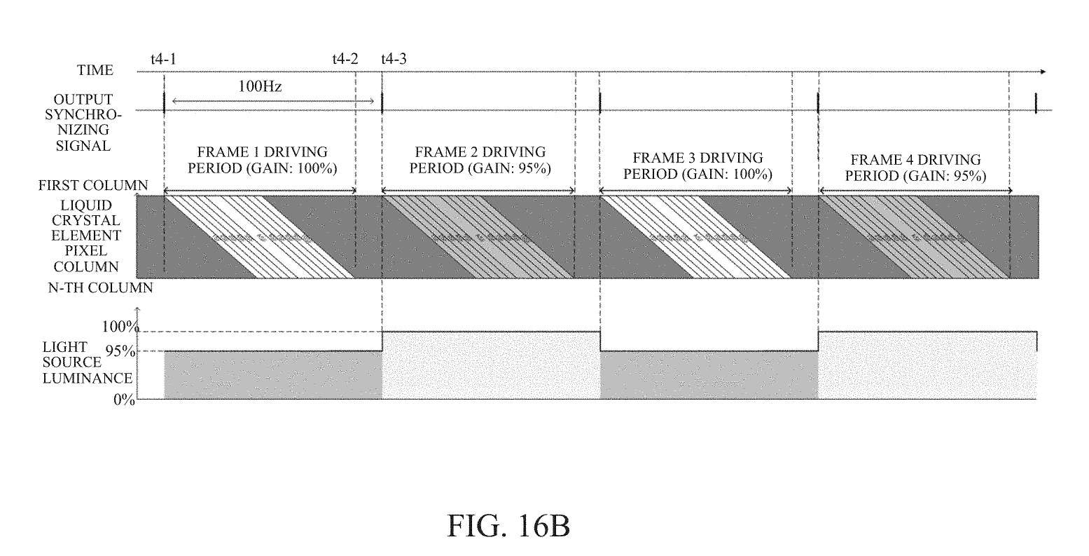

Now the gradation data according to this embodiment is compared with that in the prior art (JP2013-050681) illustrated in FIG. 32. The B subfield period as a whole follows the A subfield period in the gradation data in FIG. 32, whereas the B subfield periods are divided and arranged before and after the A subfield period in the gradation data illustrated in FIG. 5 according to this embodiment. For example, when the 48^{th} and 49^{th} gradation are addressed, 5SF and 6SF are the ON/OFF adjacent periods in the B subfield period in FIGS. 32 and 16 ON/OFF periods continue as the time weight. This is similarly applied to the 16^{th} and 17^{th} gradations, the 32^{nd} and 33^{rd} gradations, the 64^{th} and 65^{th} gradations, the 80^{th} and 81^{st} gradation, etc. On the other hand, according to this embodiment illustrated in FIG. 5, the ON/OFF periods in the B subfield period continue for one subfield period (=0.69 ms) with the time weight of 8 for any of the above adjacent gradations. The two ON/OFF periods in this one subfield period are separated from each other via the A subfield period.

Next follows a description of the effect obtained by the distributed ON/OFF periods as in this embodiment.

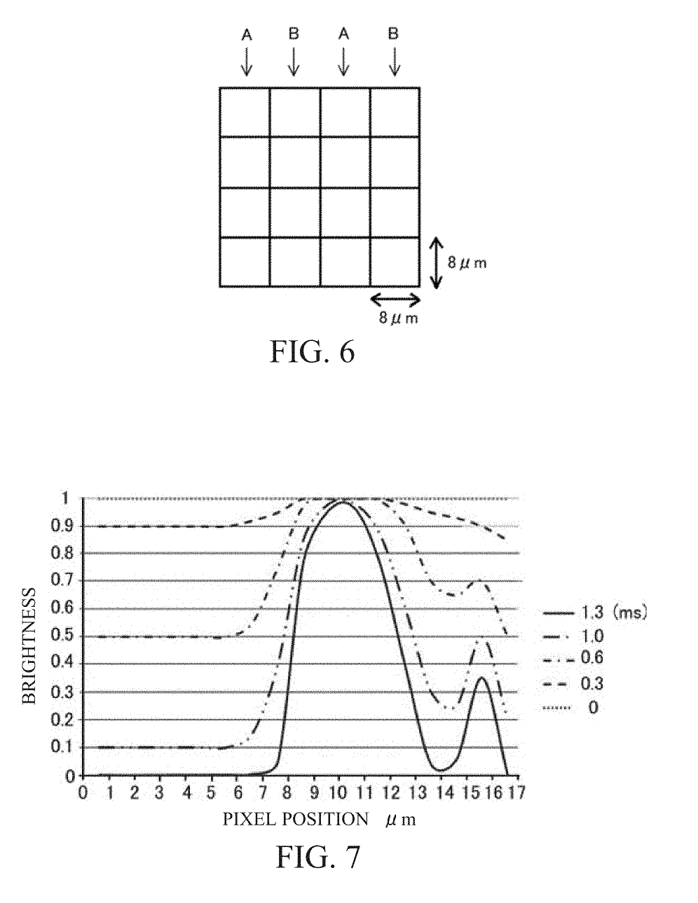

A description will now be given of a liquid-crystal response characteristic when a pixel matrix array illustrated in FIG. 6 is switched from the all-white display state to the monochromatic display state for displaying each pixel line in black and white alternately and from the all-black display state to the monochromatic display state. 4×4 pixels illustrated in FIG. 6 are arranged in a matrix shape with a pixel pitch of 8 μm. In the all-white display state, each of the pixels on the A pixel line and the pixels on the B pixel line is displayed in white in FIG. 6. In the monochromatic display state, the pixels on the A pixel line turn from the white display state to the black display state, and the pixels on the B pixel line maintain the white display states.

FIG. 7 illustrates the liquid-crystal response characteristic. The abscissa axis denotes a pixel position, and the ordinate axis denotes the brightness in each pixel that is a ratio where white is set to 1.0 to 8 μm on the abscissa axis denotes the pixel on the A pixel line illustrated in FIG. 6, and 8 to 16 μm denotes the pixel on the B pixel line. Each curve illustrates the brightness as time passes (0.3 ms, 0.6 ms, 1.0 ms, and 1.3 ms) when the all-white display state is switched to the monochromatic display state at time 0 ms.

As described above, when the pixel on the A pixel line switches from the white display state to the black display state, the brightness comparatively uniformly changes (darkens) in the pixel on the A pixel line from a pretilt angle orientation relationship in the liquid crystal without being influenced by the disclination. On the other hand, no disclination occurs in the pixel on the B pixel line in the all-white display state. However, after the pixels turn into the monochromatic display state, the brightness curve gradually distorts with time under influence of the disclination and comes to include dark lines, in particular from about 12 μm to about 16 μm.

In general, the gamma curve (gamma characteristic) for determining a drive gradation of the liquid crystal element in response to an input gradation is prepared based on a response characteristic that is made by changing a gradation while this gradation is displayed on the whole surface of the liquid crystal element having no disclination. Hence, when the liquid crystal element is driven with this gamma curve, the disclination occurs in the monochromatic display state and the brightness is lower than the original brightness due to the gamma curve.

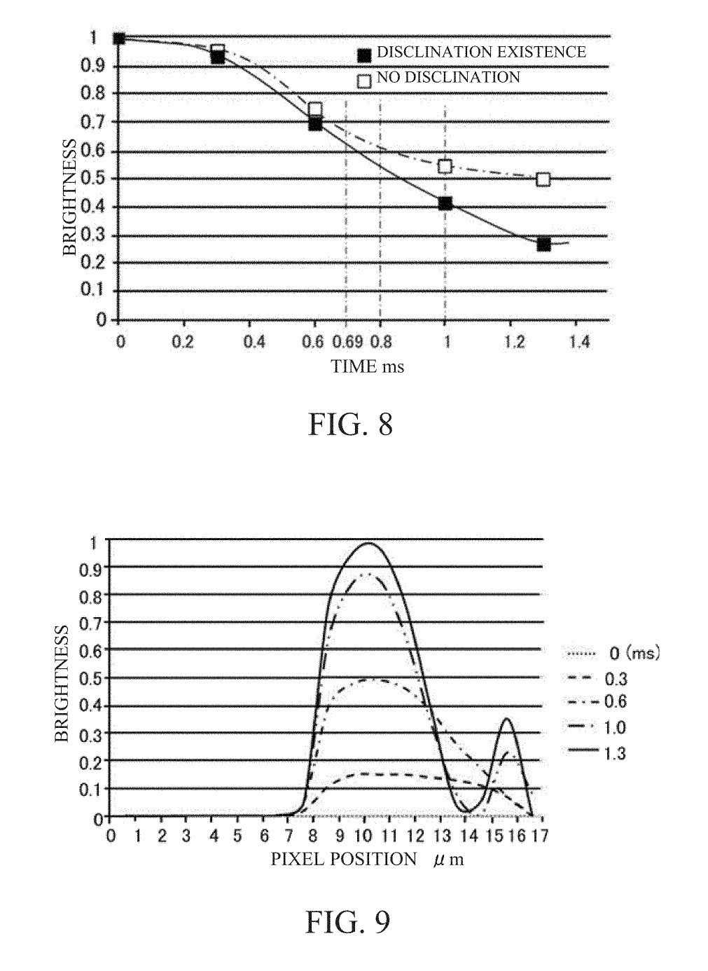

FIG. 8 illustrates a brightness change due to the disclination when the liquid crystal element is switched from the all-white state to the monochromatic display state. The abscissa axis is an elapsed time from the switching time, and the ordinate axis is a change of an integral value (simply referred to as “brightness” hereinafter) of the total brightness on the pixels on the A and B pixel lines. The brightness illustrates a ratio where the all-white display state is set to 1. When the disclination occurs (“disclination existence”), the brightness in the pixel on the A pixel line changes with a characteristic close to the response characteristic from 1 to 6 μm in FIG. 7, and the brightness in the pixel on the B pixel line becomes a white display state with the brightness of 100%. As the following time passes, a brightness reduced amount with the disclination is larger than that with (“no disclination”).

On the other hand, when the all-black display state is switched to the monochromatic display state, after the pixels on the A pixel line and the pixels on the B pixel line illustrated in FIG. 6 are displayed in black, the pixel on the A pixel line is maintained in the black display state and the pixel on the B pixel line is changed to the white display state. FIG. 9 illustrates the liquid-crystal response characteristic at this time. The abscissa axis denotes the pixel position, and the ordinate denotes the brightness in each pixel having a ratio where white is set to 1.0 to 8 μm on the abscissa axis denote the pixel on the A pixel line and 8 to 16 μm denote the pixel on the B pixel line in FIG. 6. Each curve illustrates the brightness for each elapsed time (0.3 ms, 0.6 ms, 1.0 ms, and 1.3 ms) when the all-black display state is switched to the monochromatic display state at time 0 ms.

As described above, when the pixel on the B pixel line switches from the black display state to the white display state, the brightness curve in the pixel on the B pixel line gradually distorts under influence of the disclination after the white display state as time elapses and comes to include dark lines, in particular from about 12 μm to about 16 μm. The distorted curve shape becomes remarkable as the time elapses.

As described above, in general, the gamma curve (gamma characteristic) for determining a drive gradation of the liquid crystal element in response to an input gradation is prepared based on a response characteristic that is made by changing a gradation while this gradation is displayed on the whole surface of the liquid crystal element having no disclination. Hence, when the liquid crystal element is driven with this gamma curve, the disclination occurs in the monochromatic display state and the brightness is lower than the original brightness due to the gamma curve.

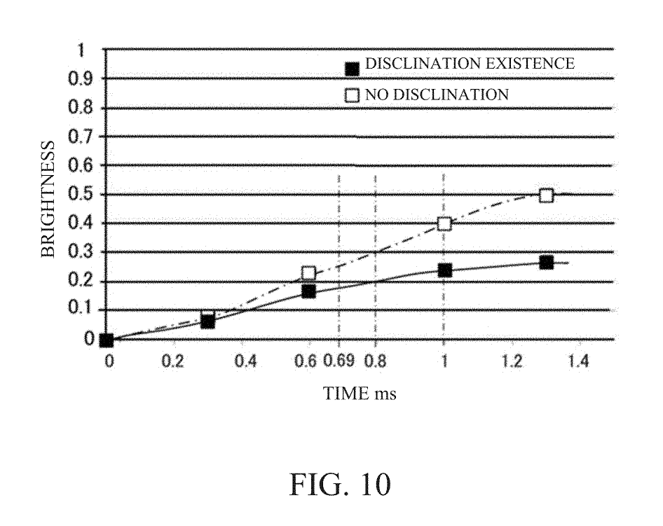

FIG. 10 illustrates a brightness change due to the disclination when the liquid crystal element is switched from the all-black state to the monochromatic display state. The abscissa axis is an elapsed time from the switching time, and the ordinate axis is a change of an integral value (simply referred to as “brightness” hereinafter) of the total brightness on the pixels on the A and B pixel lines. The brightness illustrates a ratio where the all-white display state is set to 1. When no disclination occurs (“no disclination”), the brightness changes while the pixel on the A pixel line is always the black display state and the pixel on the B pixel line changes from the black display state to the white display state. When the disclination occurs (“disclination existence”), the brightness changes as a change of the integral value of a sum of the brightness of the pixel on the A pixel line and the brightness of the pixel on the B pixel line.

In FIG. 10, when the disclination occurs, an increase amount of the brightness associated with time is less than that when no disclination occurs. In other words, as a disclination period is longer after the state is switched from the all-black display state to the monochromatic display state, the brightness is lower than that where no disclination occurs.

Next follows a description where the pixels on the A pixel line display the 48^{th} gradation and the pixels on the B pixel line display the 49^{th} gradation with the conventional gradation data illustrated in FIG. 32. With this gradation data, the disclination occurs in 5SF and 6SF in the B subfield periods in which the pixels on the A pixel line are displayed in black and the pixels on the B pixel line are displayed in white. In 4SF before 5SF, each of the pixels on the A pixel line and the pixels on the B pixel line is displayed in white and no disclination occurs.

The liquid-crystal response characteristic from 5SF to 6SF corresponds to the characteristic “disclination existence” in FIG. 8. The all-white display state in 4SF has the output brightness of 100%, and the disclination occurs in a period of 1.39 ms from when 5SF starts to when 6SF ends. The start time of 5SF corresponds to 0 ms, and the end time of 6SF corresponds to 1.39 ms in FIG. 8. Then, the brightness lowers down to 0.27 whereas the brightness lowers down to 0.5 when no disclination occurs. As described above, based on the gamma characteristic prepared with the same gradation on the entire surface, the ratio becomes as dark as 54% (=0.27/0.5) in the disclination period from 5SF to 6SF.

Next follows a description of this embodiment where the pixels (second pixel) on the A pixel line display the 48^{th} gradation with the gradation data illustrated in FIG. 5 and the pixels (first pixel) on the B pixel line display the 49^{th} gradation. With this gradation data, the disclination occurs in 4SF and 7SF in the B subfield periods in which the pixels on the A pixel line and the pixels on the B pixel line display the disclination. In 3SF before 4SF, each of the pixels on the A pixel line and the pixels on the B pixel line is displayed in white and no disclination occur.

The liquid-crystal response characteristic in 4SF corresponds to a characteristic “disclination existence” in FIG. 8. The all-white display state in 3SF has the output brightness of 100%. The disclination occurs in a period of 0.69 ms in 4SF, the start time of 4SF corresponds to 0 ms, and the end time of 4SF corresponds to 0.69 ms in FIG. 8. Then, the brightness lowers down only to 0.65 whereas the brightness lowers down to 0.7 when no disclination occurs.

The other liquid-crystal response characteristic in 7SF in the disclination subfield period corresponds to a characteristic “disclination existence” in FIG. 10. The all-white display state in 6SF has the output brightness of 100%, and the disclination occurs in a period of 0.69 ms in 7SF. The start time of 7SF corresponds to 0 ms, and the end time of 7SF corresponds to 0.69 ms in FIG. 10. Then, the brightness lowers down only to 0.18 whereas the brightness lowers down to 0.25 when no disclination occurs.

A sum of the brightness with no disclination in 4SF and 7SF is 0.95 (=0.70+0.25) whereas that with the disclination is 0.83 (=0.65+0.18). As described above, based on the gamma characteristic prepared with the same gradation on the entire surface, the brightness is as dark as a ratio of 87% (=0.83/0.95) in the disclination display state. In other words, this embodiment can restrain a brightness drop.

Next follows a description of displaying other adjacent gradations. Initially, a description will be given where the pixels on the A pixel line illustrated in FIG. 6 display the 16^{th} gradation and the pixels on the B pixel line display the 17^{th} gradation with the conventional gradation data illustrated in FIG. 32. With the gradation data, the disclination occurs in 1SF and 2SF in the B subfield period in which the pixels on the A pixel line are displayed in black and the pixels on the B pixel line are displayed in white.

The liquid-crystal response characteristic from 1SF to 2SF corresponds to a characteristic “disclination existence” in FIG. 10. The disclination occurs in a period of 1.39 ms from when 1SF starts to when 2SF ends. The start time of 1SF corresponds to 0 ms, and the end time of 2SF corresponds to 1.39 ms in FIG. 10. Then, the brightness lowers down to 0.27 whereas the brightness lowers down to 0.5 when no disclination occurs. As described in the first embodiment, based on the gamma characteristic prepared with the same gradation on the entire surface, the brightness is as dark as a ratio of 54% (=0.27/0.5) in the disclination period from 1SF to 2SF.

Next follows a description of this embodiment where the pixel (second pixel) on the A pixel line displays the 16^{th} gradation with the gradation data illustrated in FIG. 5 and the pixel (first pixel) on the B pixel line displays the 17^{th} gradation. With the gradation data, the disclination occurs in 3SF and 8SF in the B subfield periods in the disclination display state of the pixels on the A pixel line and the pixels on the B pixel line. In 2SF before 3SF, each of the pixels on the A pixel line and the pixels on the B pixel line displays black and no disclination occurs. The liquid-crystal response characteristic in 3SF corresponds to a characteristic “disclination existence” in FIG. 10. The all-black display state in 2SF has the output brightness of 0%, and the disclination occurs in a period of 0.69 ms in 3SF. The start time of 3SF corresponds to 0 ms, and the end time of 3SF corresponds to 0.69 ms in FIG. 10. Then, the brightness lowers down only to 0.18 whereas the brightness lowers down to 0.25 when no disclination occurs.

The other liquid-crystal response characteristic in 8SF in the disclination subfield period corresponds to a characteristic “disclination existence” in FIG. 10. The all-black display state in 7SF has the output brightness of 0%, and the disclination occurs in a period of 0.69 ms in 8SF. The start time of 8SF corresponds to 0 ms, and the end time of 8SF corresponds to 0.69 ms in FIG. 10. Then, the brightness lowers down only to 0.18 whereas the brightness lowers down to 0.25 when no disclination occurs.

A sum of the brightness with no disclination in 3SF and 8SF is 0.50 (=0.25+0.25) whereas that with the disclination is 0.36 (=0.18+0.18). As described above, based on the gamma characteristic prepared with the same gradation on the entire surface, the disclination display state is as dark as a ratio of 72% (=0.36/0.95). In other words, this embodiment can restrain a brightness drop.

Thus, this embodiment separates (distributes) a plurality of ON/OFF periods as the disclination display states from each other in the one frame period in displaying the adjacent gradations, and shortens the one continuing ON/OFF period. In other words, before the brightness drop caused by the disclination stands out, the disclination display state in the adjacent pixels may be transferred to another display state. This configuration can restrain the brightness drop caused by the disclination, makes less conspicuous the dark lines, and can display a good-quality image.

The above liquid crystal element driving method can restrain the disclination. However, in order to further prevent the dark lines from standing out, this embodiment can also use the following driving method.

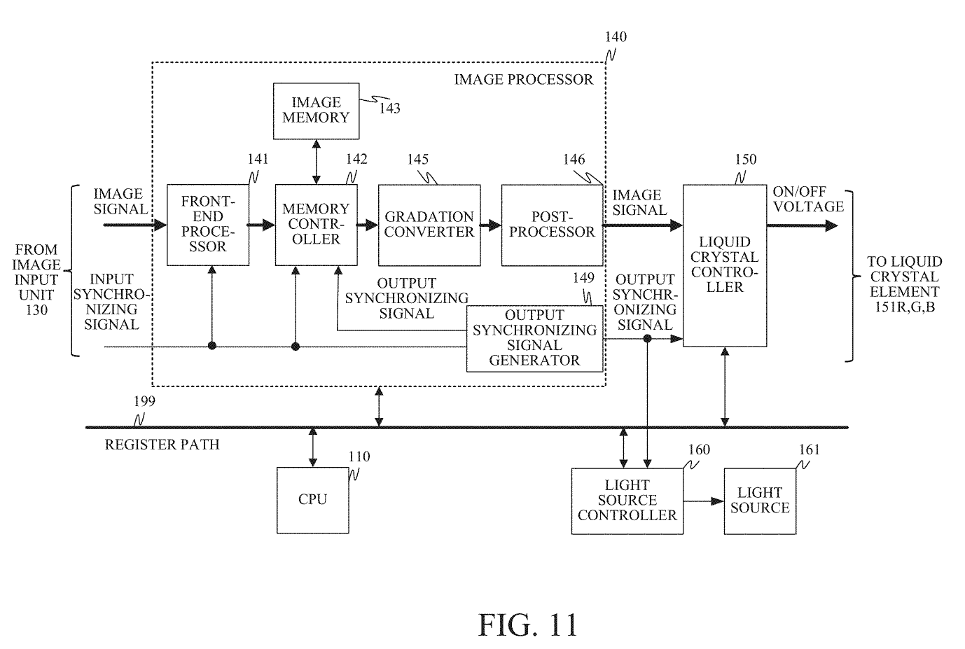

Referring to FIG. 11, a description will be given of the internal structure of the image processor 140 and the liquid crystal controller 150. The image processor 140 includes a front-end processor 141, a memory controller 142, an image memory 143, a gradation converter 145, a postprocessor 146, and an output synchronizing signal generator 149. Each component in the image processor 140 is connected to the CPU 110 through the register bus 199.

The front-end processor 141 converts an image signal from the image input unit 130 into image data having a color space and a resolution suitable for the liquid crystal element 151. More specifically, the front-end processor 141 provides display layout conversion processing that contains a color space conversion and enlargement/reduction processing to the image signal.

The memory controller 142 provides conversion processing on the time axis, such as IP conversion processing and frame rate conversion processing, issues a memory address in the image memory 143 used to correct the projection image shape, and controls writing and reading of an image. The frame rate conversion processing of the memory controller 142 contains a frame rate doubling process to be realized by twice reading the same frame image data from the image memory 143. Either case controls writing of image data in synchronization with the input synchronizing signal for the image memory 143 and reading the image data in synchronization with the output synchronizing signal.

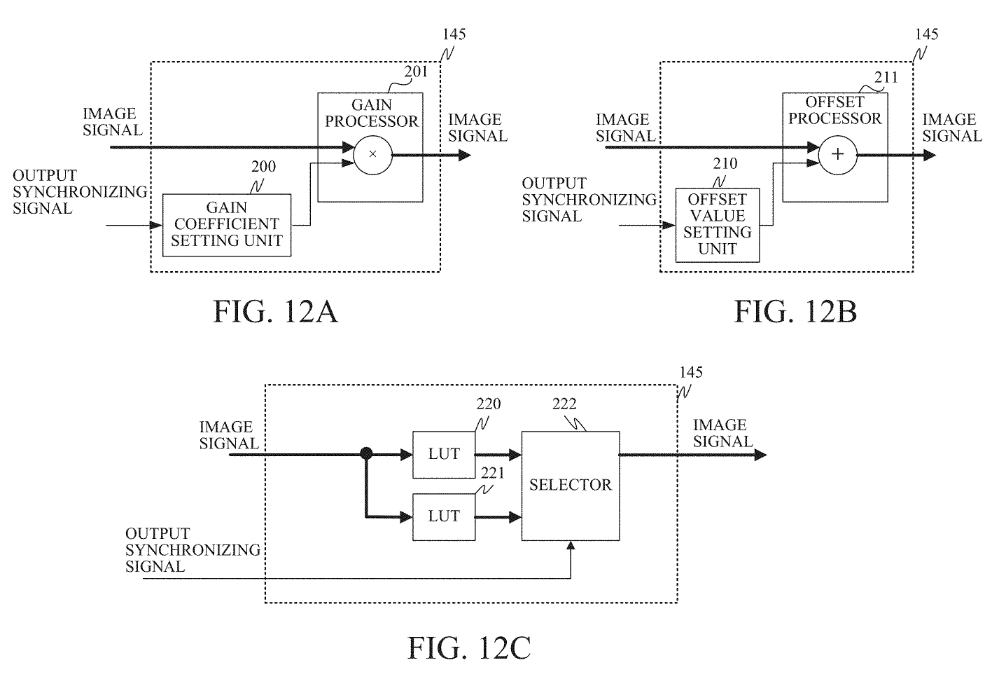

The gradation converter 145 performs different conversion processing for each frame (input frame image data) for the input image data. FIG. 12A illustrates a structure of the gradation converter 145. The gradation converter 145 includes a gain coefficient setting unit 200 and a gain processor 201.

The gain coefficient setting unit 200 sets a different gain coefficient for each frame in synchronization with the input output synchronizing signal, and notifies the gain processor 201 of it. This embodiment sets a gain coefficient of 100% to a certain frame and a gain coefficient of 95% to the next frame. The gain processor 201 provides gain processing for (applying the gain or) multiplying the image signal by the gain coefficient set by the gain coefficient setting unit 200. Data made by applying the gain to an input frame may be referred to as a subframe.

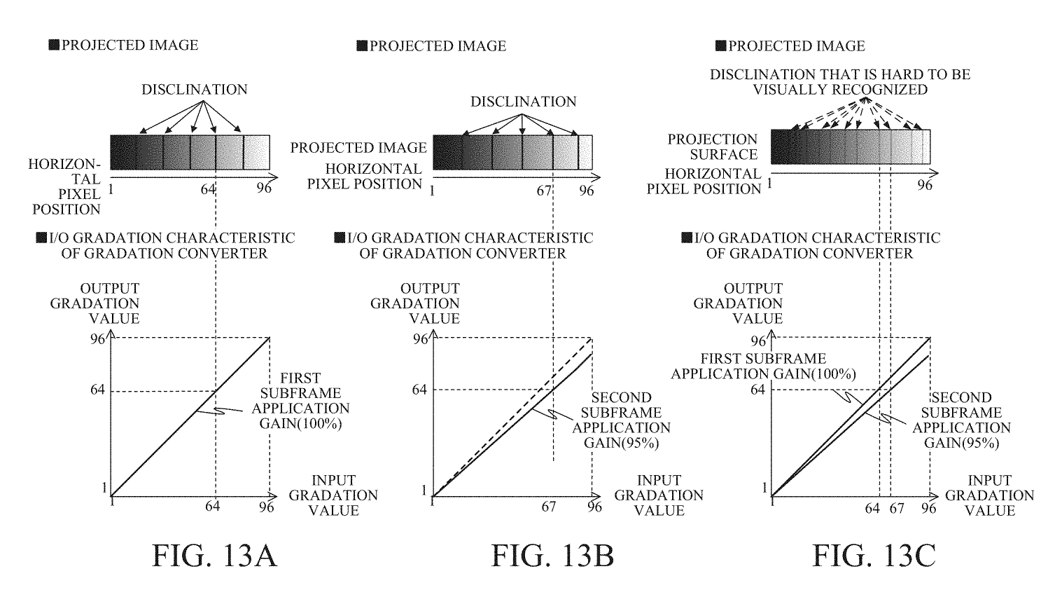

The different gain process for each frame by the gradation converter 145 can prevent the pixel brightness drop caused by the disclination from being easily visually recognized. Referring now to FIGS. 13A to 13C, a description will be given of this principle.

FIG. 13A illustrates a relationship (I/O gradation characteristic) between an input gradation value as a gradation value of input frame image data when the gain coefficient is 100% and an output gradation value corresponding to a drive gradation value of the liquid crystal element 151, and a projected image as a display image visually recognized by the observer. The liquid crystal element 151 according to this embodiment has 96 pixels in the horizontal direction. In displaying the gradation image in which the gradation simply increases one by one in the right direction, the following description assumes five dark lines caused by the disclination as illustrated in FIG. 13A.

Now address the disclination at adjacent positions with input gradation values 64 and 65. Referring now to FIG. 13B, a description will be given of a change of a disclination position when the gain coefficient of 95% is applied to the gradation image. The gain processing with the gain coefficient of 95% moves the adjacent gradation values 64 and 65 to the pixel positions 67 and 68. Hence, the dark line caused by the disclination occurs at the position 67 that displays the gradation value 64.

Since the gradation converter 145 alternately switches the gain coefficient between 100% and 95% for each frame, the projected image is alternately switched between the image illustrated in FIG. 13A and the image illustrated in FIG. 13B for each frame. When this switching period is equal to or longer than a predetermined value, the observer can visually recognize the integral image for two frames and the dark lines caused by the disclination with a concentration of about ½ as illustrated in FIG. 13C. This is a reason why the operation of the gradation converter 145 prevents the dark lines caused by the disclination from being easily visually recognized. This principle is similarly applied to the disclination at other positions.

The postprocessor 146 provides correction processing that corrects an uneven display, such as uneven coloring and an uneven luminance, caused by the liquid crystal element 151 and the projection optical system 171, the disclination, etc. The postprocessor 146 also provides image processing, such as a gamma conversion suitable for the gradation of the liquid crystal element 151, etc.

The output synchronizing signal generator 149 generates an output synchronizing signal by counting reference clocks as bases of the input unillustrated dot clock. This output synchronizing signal is used as a reference signal for reading of the image memory 143 by the memory controller 142, and for synchronizing the postprocessor 146 and finally the update timing of the liquid crystal element 151 driven by and the liquid crystal controller 150.

Next follows a description of an ON/OFF updating timing of a predetermined voltage (simply referred to as “voltage on/off” hereinafter) for each pixel in the liquid crystal element 151 according to this embodiment. This embodiment updates the voltage on/off for all pixel columns (or all pixels) in the liquid crystal element 151 at the same timing. Hence, the liquid crystal element 151 has a data IF bus having a width for simultaneously receiving the voltage on/off data for all pixels from the liquid crystal controller 150. In order to reduce the number of data IF buses, the liquid crystal element 151 may include a storage for temporarily storing the voltage on/off data. In other words, the liquid crystal element 151 sequentially receives the voltage on/off data for each pixel or pixel column from the liquid crystal controller 150, and temporarily stores it in the storage. Then, the liquid crystal element 151 receives the voltage on/off data for all pixels, and simultaneously provides the voltage on/off to all pixels. Thereby, the voltage on/off for all pixels can be simultaneously updated.

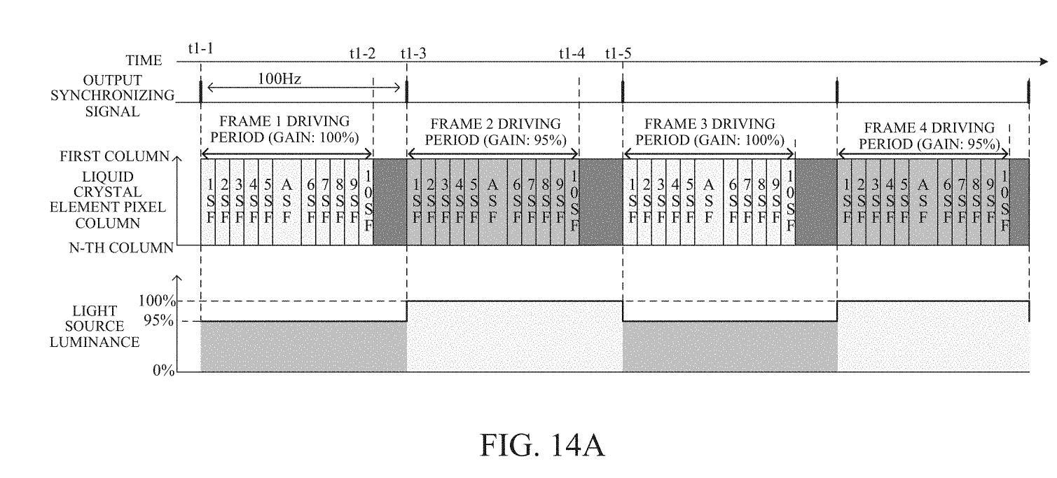

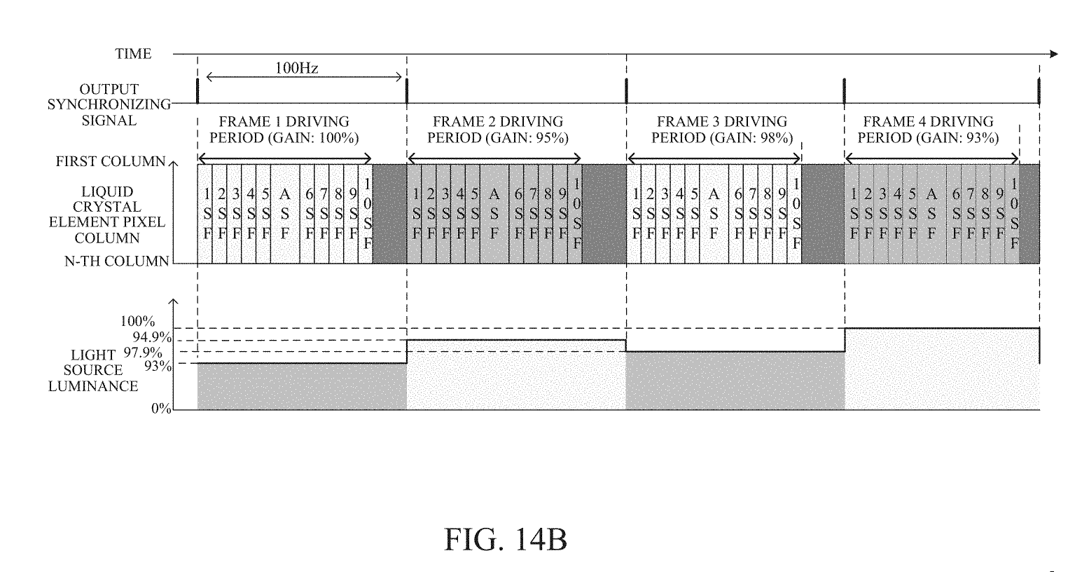

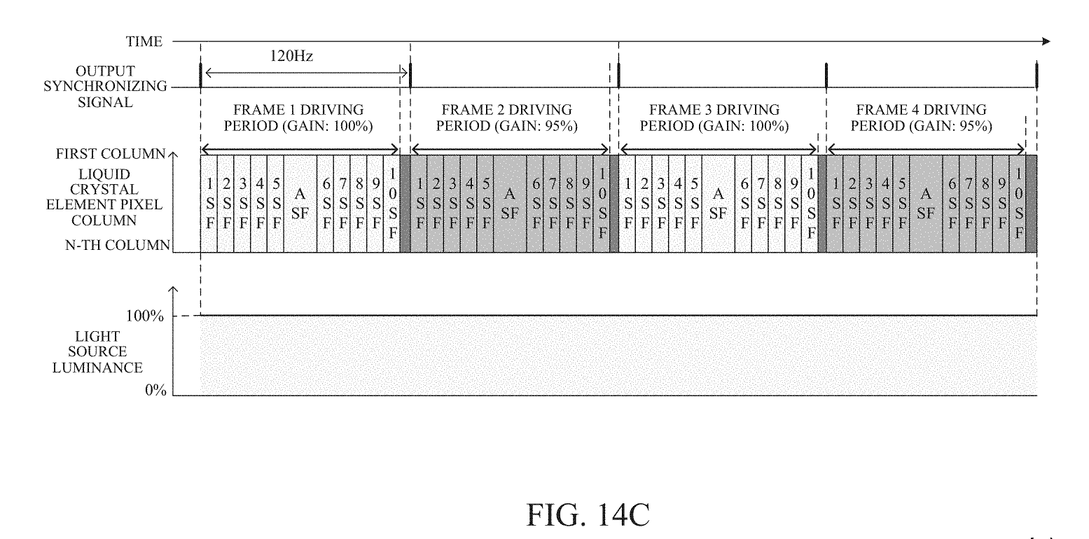

FIG. 14A illustrates the update timing when the voltage on/off is simultaneously updated for all pixels in the liquid crystal element 151. Herein, the gain processing by the above gradation converter 145 alternately switches the gain coefficient for each frame (simply referred to as the “gain” hereinafter) between 100% and 95%.

Initially, the driving period for the frame 1 (gain 100%) starts in synchronization with the output synchronizing signal at time t1-1. The liquid crystal controller 150 sends the voltage on/off data to the liquid crystal element 151 in order from 1SF described with FIG. 5 in accordance with the output gradation value expressed by the gradation data of the frame 1. The liquid crystal element 151 provides the voltage on/off to each pixel in 1SF based on the received data. Thereafter, similarly, the liquid crystal 151 sequentially provides the voltage on/off to all pixels for each subfield such as 2SF, 3SF, etc. Thereby, when the voltage on/off ends to 10SF at time t1-2, the voltage is turned off for all pixels in the blanking period until the next frame 2 driving period starts.

In the frame 2 (gain 95%) driving period, similar to the frame 1, the voltage on/off is sequentially provided to all pixels for each subfield. In other words, the voltage on/off starts at time t1-3 for all pixels in 1SF in the frame 2, the voltage on/off for 10SF ends at time t1-4, and the frame 2 driving time ends.

Thereafter, similarly, the voltage on/off is sequentially performed for all pixels in each subfield in the frame 3 (gain 100%) driving period, the frame 4 (95%) driving period, etc.

Next follows a description of the luminance control in the light source 161 by the light source controller 160. The light source controller 160 sets the luminance in the light source 161 (referred to as a “light source luminance” hereinafter) in synchronization with the driving period of the liquid crystal element 151 as follows:

(gain coefficient for frame 1)×(light source luminance for frame 1)=(gain coefficient for frame 2)×(light source luminance for frame 2)

The luminance of the light source 161 may be 100% in a frame driving period with a small gain coefficient. If it is assumed that the light source luminance is 100% in the frame 2 driving period, the light source luminance in the frame 1 driving period is set as follows:

100×(light source luminance in frame 1 driving period)=95×100

In other words, the following expression is satisfied:

(light source luminance in frame 1 driving period)=95%

The light source controller 160 may control the luminance of the light source 161 by setting the light source luminance E1 for the frame 1 and the light source luminance E2 for the frame 2 as follows. X is an input gradation value, Y1 is an output gradation value in a certain pixel in the frame 1. Y2 is an output gradation value of a certain pixel in the frame 2, and A is a gain coefficient.

E1=(2−A)X/Y1

E2=(2−A)X/Y2

Thus, the output luminance may be made constant or (2−A) times as large as the input by controlling the luminance of the light source 161 irrespective of the frame.

FIG. 14A illustrates the voltage on/off updating timing in the liquid crystal element 151 and the luminance changing timing in the light source 161. The light source controller 160 changes the luminance of the light source 161 so as to reduce (cancel) the gradation change in the liquid crystal element 151 for each frame caused by the different gradation conversion processing (gain processing) for each frame by the gradation converter 145 or the changes in the projected image. When an image signal with a low frame rate is input, this configuration can restrain flickers associated with the gradation conversion processing that makes the disclination hard to be visually recognized.

The gain coefficient setting unit 200 in the gradation converter 145 switches the gain coefficients between two values or 100% and 95% for each frame, but the number of gain coefficients is not limited to two. For example, four gain coefficients (100%, 95%, 98%, and 93%) may be switched for each frame. This configuration can move the disclination position to four positions and further prevent the pixel brightness drop from being easily visually recognized. In addition, in switching the gain coefficients among four values, the light source controller 160 controls the luminance of the light source 161 (light source luminance) as follows:

$$( gain coefficient for frame 1 ) \times ( light source luminance for frame 1 ) = ( gain coefficient for frame 2 ) \times ( light source luminance for frame 2 ) = ( gain coefficient for frame 3 ) \times ( light source luminance for frame 3 ) = ( gain coefficient for frame 4 ) \times ( light source luminance for frame 4 )$$

If it is assumed that the light source luminance for the frame 4 is 100%, the light source luminances for the frames 1 to 3 are set as follows:

$$100 \times ( light source luminance for the frame 1 ) = 95 \times ( light source luminance for the frame 2 ) = 98 \times ( light source luminance for the frame 3 ) = 93 \times 100$$

In other words, the following expressions are satisfied.

(light source luminance for the frame 1)=93%

(light source luminance for the frame 1)=97.9%

(light source luminance for the frame 1)=94.9%

FIG. 14B illustrates the voltage on/off updating timing in the liquid crystal element 151 and the luminance changing timing in the light source 161.

As illustrated in FIG. 12C, the gradation converter 145 may perform the gradation conversion processing with a lookup table (LUT) as a plurality of gradation conversion data tables that correlate the different output gradation values (drive gradation values) with the input gradation values. The LUT 220 is a data table that stores the gradation conversion data corresponding to the I/O gradation characteristic illustrated in FIG. 13A, and the LUT 221 is a data table that stores the gradation conversion data corresponding to the I/O gradation characteristic illustrated in FIG. 13B. A selector 222 switches the LUT to be referred to for each frame between the LUT 220 and the LUT 221 in synchronization with the output synchronizing signal. This configuration can drive the liquid crystal element 151 in accordance with the different I/O gradation characteristics for each frame and prevent the pixel brightness drop caused by the disclination from being easily visually recognized. The light source controller 160 provides the luminance control in the light source 161 as illustrated in FIGS. 14A and 14B when the gradation converter 145 performs this gradation conversion processing.

The LUTs 220 and 221 may store the gradation conversion data for all gradations, but this structure will increase the data capacity. Thus, they may store only output gradation values for a plurality of representative input gradation values and calculate an output gradation value for another input gradation value through an interpolation.

The gradation converter 145 may perform offset processing as illustrated in FIG. 12B. This gradation converter 145 includes an offset value setting unit 210 and an offset processor 211.

The offset value setting unit 220 sets a different offset value for each frame in synchronization with an output synchronizing signal, and informs the offset processor 211 of it. For example, assume an offset value of +30 for a certain frame and an offset value of −30 for the next frame. The offset processor 211 performs as the gradation conversion processing the offset processing that adds or subtracts the offset value set by the offset value setting unit 210.

FIGS. 14A and 14B illustrate the luminance control of the light source 161 by the light source controller 160 when the gradation converter 145 performs the offset processing. In this case, the light source controller 160 calculates an average growth rate of the luminance for each frame caused by the offset processing, and controls the luminance (light source luminance) of the light source 161 as follows. The average growth rate of the luminance can be calculated based on the offset value and a previously measured relationship between the gradation and luminance characteristic in the liquid crystal element 151.

(average growth rate of luminance for frame 1)×(light source luminance for frame 1)=(average growth rate of luminance for frame 2)×(light source luminance for frame 2)

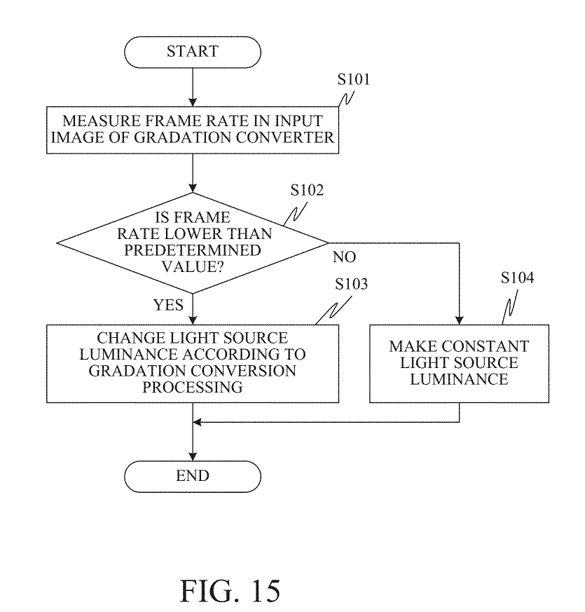

The CPU 110 may determine whether the luminance of the light source 161 is to be changed for each frame as illustrated in FIGS. 14A and 14B in accordance with the change period of the gradation conversion processing by the gradation converter 145 and the flowchart illustrated in FIG. 15. The CPU 110 and the light source controller 160 execute the following liquid crystal display processing (liquid crystal display method) in accordance with the liquid crystal display program as a computer program.

In S101, the CPU 110 as a measurement unit calculates a frame rate of input image data input to the gradation converter 145. This frame rate is calculated based on the frame rate of the image signal input into the image input unit 130 and the conversion rate in the frame rate conversion processing performed by the memory controller 142. For example, assume that an image signal of 24 Hz is input to the image input unit 130 and the memory controller 142 has performed processing that quadruples the frame rate. Then, the frame rate of the input image data input to the gradation converter 145 becomes 24 Hz×quad-speed=96 Hz.

In S102, the CPU 110 determines whether or not the frame rate calculated in S101 is lower than a predetermined value, and moves to S103 when the frame rate is lower than the predetermined value. On the other hand, when the calculated frame rate is equal to or higher than the predetermined value, the flow moves to S104. The predetermined value is set to an upper limit value of the frame rate, such as 120 Hz, at which the observer is likely to visually recognize the luminance change of the projected image caused by the gain processing that is different for each frame by the gradation conversion processor 145. When the frame rate is 120 Hz or higher, the observer has difficulties in visually recognizing the luminance change of the projected caused by the gain processing that is different for each frame and thus it is unnecessary to change the luminance of the light source 161 for each frame.

In S103, the CPU 110 instructs the light source controller 160 to change the luminance of the light source 160 in synchronization with the change of the gradation conversion processing by the gradation converter 145 as described with reference to FIG. 14A. This configuration can restrain the flickers along the gradation conversion processing that makes the disclination hard to be visually recognized, as described above.

On the other hand, in S104, the CPU 110 instructs the light source controller 160 to control the luminance of the light source 161 so as to make it constant as illustrated in FIG. 14C. This configuration can prevent the brightness of the unnecessary projected image from lowering at the frame rate at which the flickers are less likely to be visually recognized, when the gradation conversion processing is performed which makes the disclination hard to be visually recognized.

### Second Embodiment

Next follows a description of a liquid crystal projector according to a second embodiment of the present invention. The structure of the liquid crystal projector according to this embodiment is similar to that illustrated in FIG. 1. The gradation converter 145 according to this embodiment alternately switches the gain coefficient for each frame between 100% and 95% as described with reference to FIGS. 13A to 13C in the first embodiment. Unlike the all-pixel updating method that simultaneously updates the voltage on/off of all pixels in the liquid crystal element 151 described in the first embodiment, this embodiment adopts a scan updating method that sequentially updates the voltage on/off of the liquid crystal element 151 for each pixel column (or part of pixels). This scan updating method can also obtain effects similar to those of the first embodiment. Referring now to FIG. 16A, a description will be given of the power on/off update timing in the liquid crystal element 151 in the scan updating method according to this embodiment.

A description will now be given of the power on/off update timing for pixels in one pixel column in the liquid crystal element 151. At time t3-1, a 1SF period starts for the first pixel column in the liquid crystal element 151 in synchronization with the output synchronizing signal for the frame 1 (gain 100%). The liquid crystal controller 150 sends the voltage on/off data to the liquid crystal element 151 in order from 1 SF described with reference to FIG. 5 in accordance with the output gradation value for the frame 1. The liquid crystal element 151 provides the voltage on/off to the pixels in the first pixel column in 1SF based on the received data. Thereafter, similarly, the voltage on/off is sequentially performed for each pixel in the first pixel column in each subfield, such as 2SF, 3SF, etc. When the voltage on/off ends to 10SF at time t3-3, the voltage is turned off for all pixels on the first pixel column in the blanking period until the driving period for the next frame 2 starts. This is the voltage on/off updating timing for pixels on the first pixel column in the liquid crystal element 151, and this is equal to the voltage on/off update timing for all pixels described in the first embodiment.

On the other hand, the power on/off updating timing for pixels in the second column to the N-th pixel column in the liquid crystal element 151 is different from that for the pixels in the first pixel column. 1SF starts with the second pixel column after the 1SF starting time t3-1 for the first pixel column, and 1SF starts with the third pixel column after the 1SF starting time for the second pixel column. Thus, 1SF starts with each pixel column in the liquid crystal element 151 in order from the first pixel column to the N-th pixel column and 1SF starts with the N-th pixel column at time t3-2.

1SF sequentially starts with each pixel column in the liquid crystal element 151 and it is unnecessary to widen the data bus unlike the first embodiment and to provide a storage for temporarily store the voltage on/off data. Thus, the liquid crystal element 151 can have a simpler structure.

The liquid crystal element 151 has an equal time period from when 1SF starts to when 10SF ends in each pixel column, which is also equal to that in the first embodiment. The voltage on/off updating timing for each of the frame 2 to the frame 4 is equal to that for the frame 1. The power on/off updating period starts for the first pixel column in 1SF in synchronization with the output synchronizing signal, and the power on/off is sequentially updated for the second and subsequent pixel columns.

The power on/off updated for each pixel column in the liquid crystal element 151 may cause concurrent frame driving periods. For example, from time t3-4 to time t3-5, the upper pixel column, such as the first pixel column, in the liquid crystal element 151 is located in the frame 2 (gain 95%) driving period whereas the lower pixel column, such as the N-the pixel column, is located in the frame 1 (gain 100%) driving period. In this case, as illustrated in FIG. 16A, similar to the first embodiment, when the light source controller 160 changes the light source luminance in synchronization with the frame synchronizing signal, the illumination light quantity entering the liquid crystal element 151 changes at some point in the one frame and the gradation quality of the projected image may lower.

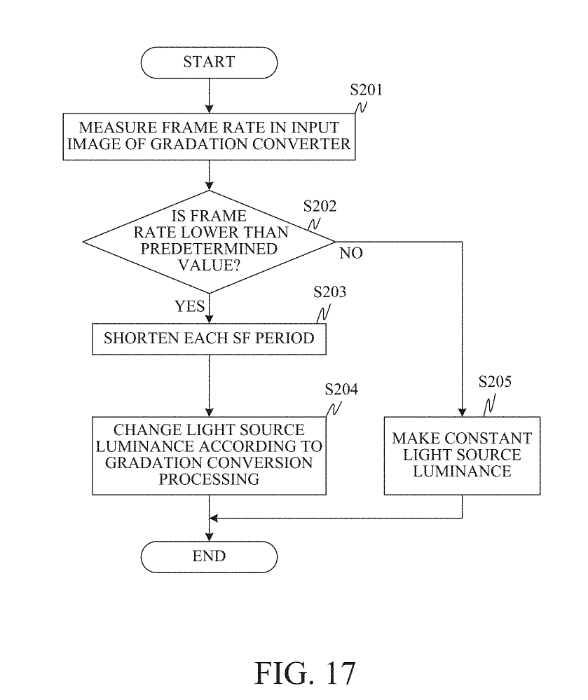

Accordingly, the CPU 110 according to this embodiment provides the liquid crystal display processing illustrated in a flowchart in FIG. 17.

Since S201 and S202 are the same as S101 and S102 in FIG. 15, a description thereof will be omitted. In S203, the CPU 110 instructs the liquid crystal controller 150 to shorten the voltage application period for the liquid crystal element 151 and to eliminate concurrent driving periods for the different frames, such as the frame 1 and the frame 2. The liquid crystal controller 150 shortens the voltage application period in each subframe in accordance with the command from the CPU 110, such as, as illustrated in FIG. 16B. FIG. 16B illustrates an example for approximately halving the voltage application period in each subfield. To what extent the voltage application period is reduced can be determined based on the predetermined subfield period and the frame rate of the input image data calculated in S201.

Next, in S204, the CPU 110 instructs the light source controller 160 to change the luminance of the light source 161 in synchronization with the gradation conversion processing by the gradation converter 145 similar to the first embodiment (FIG. 14A). FIG. 16B illustrates the luminance of the light source 161 in each frame.

This embodiment can restrain the flickers associated with the gradation conversion processing that makes the disclination hard to be visually recognized when an input image with a low frame rate is input. In addition, since all pixels in the same frame in the liquid crystal element 151 are driven in a period shorter than a luminance changing period of the light source 161 (intensity of the illumination light), this embodiment can prevent the gradation deterioration caused by the changing luminance of the light source 161 in the driving period of the same frame.

In S205, similar to S104 in FIG. 15, the CPU 110 instructs the light source controller 160 to maintain constant the luminance in the light source 161. This configuration can prevent the unnecessary brightness drop in the projected image in the frame rate that makes the flickers hard to be visually recognized even with the gradation conversion processing.

### OTHER EMBODIMENTS

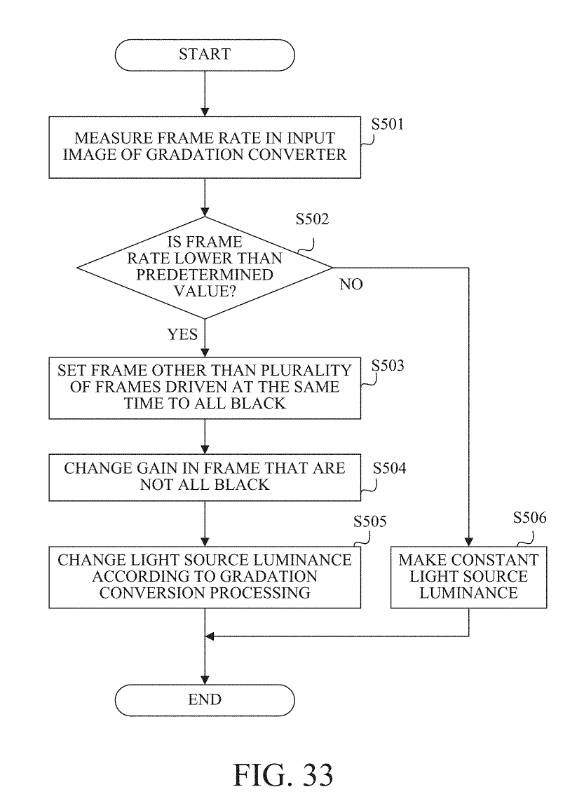

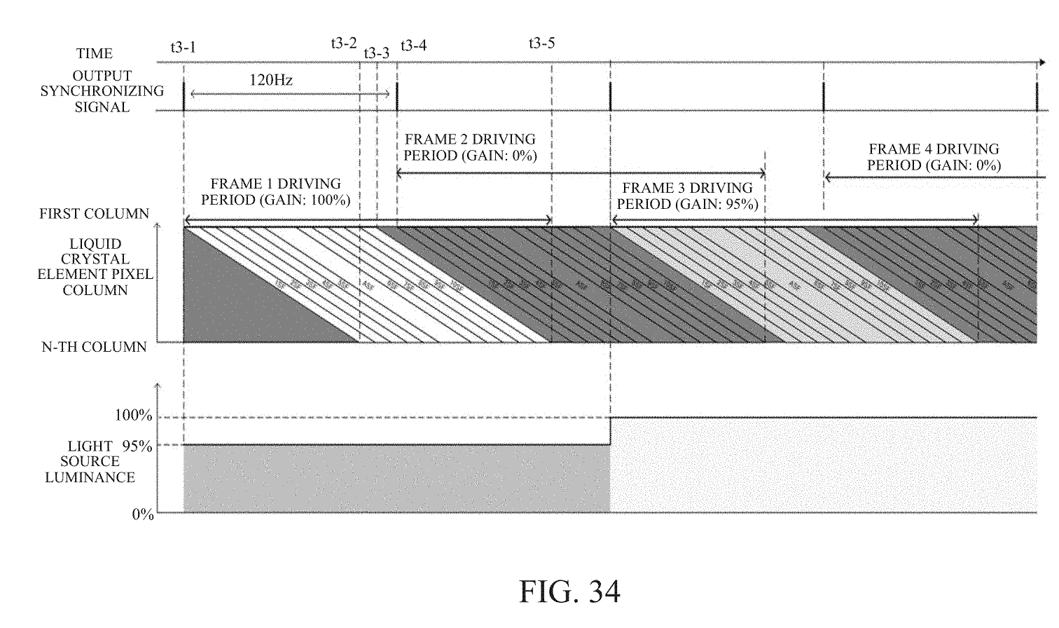

Next follows a description of another example that controls (shortens) the voltage application period for the liquid crystal element 151 so as to eliminate concurrent driving periods for different frames, such as the frame 1 and the frame 2. For example, one embodiment may control driving the liquid crystal element 151 so that a frame other than one (non-all-black display frame) of a plurality of frames that are concurrently driven can be of an all-black display. A flowchart illustrated in FIG. 33 illustrates processing performed by the CPU 110 according to this embodiment. FIG. 34 illustrates the gradation updating timing in the light crystal element and the brightness changing timing in the light source in this processing.

S501, S502, and S506 are the same as S101, S102, and S104 in FIG. 15, and a description thereof will be omitted.

In S503, the CPU 110 instructs the gradation converter 145 so that a frame (referred to as a “non-display frame:” frame 2 or 4 in FIG. 34 hereinafter) other than one (referred to as a “display frame:” frame 1 or 3 in FIG. 34 hereinafter) of a plurality of frames that are concurrently driven can be of an all-black display (or non-display). The gradation converter 145 drives the liquid crystal element 101 so that the frames 2 and 4 can be of an all-black display, by applying the gain of 0% to the frames 2 and 4.

For example, the gradation converter 145 applies the gain of 100% to the frame 1, and the gain of 95% to the frame 3.

Next, in S505, the CPU 110 instructs the light source controller 160 to change the luminance of the light source 161 in synchronization with the gradation conversion processing of the gradation converter 145. Then, the driving periods of the all-black display frames, such as the frames 2 and 4, are ignored, and the gradation conversion processing to the frames 1 and 3 is synchronized with the luminance changing process in the light source 161 as illustrated in FIG. 34.

Moreover, the light source luminance in each driving period is set as follows:

(gain for frame 1:100%)×(light source luminance in frame 1 driving period)=(gain for frame 3:95%)×(light source luminance in frame 3 driving period)

This is the driving example of the liquid crystal element 151 by the scan updating method. This embodiment can restrain the flickers associated with the gradation conversion processing that makes the disclination hard to be visually recognized, when an input image with a low frame rate is input. Moreover, this example does not change the luminance of the light source 161 in the driving period for the frame other than the all-black display frame, and can prevent the gradation deterioration.

In order to improve the visual recognizability of a motion image projected from the liquid crystal projector, a technology that entirely displays one of continuing frames in black (referred to as a “black insertion” hereinafter) is proposed. When an image in which the frames 2 and 4 are entirely displayed in black by the black insertion is input to the gradation converter 145, S503 in FIG. 33 may be skipped and S504 and S506 may be executed.

### Third Embodiment

Next follows a description of a liquid crystal projector according to a third embodiment of the present invention. The liquid crystal projector according to this embodiment displays a left-eye image and a right-eye image for a three-dimensional view through a time division. The basic configuration of the liquid crystal projector according to this embodiment is similar to that according to the first embodiment, but an image signal for the three-dimensional view is input to the image input unit 130. In general, a pair of a left-eye image and a right-eye image form one frame in the image for the three-dimensional view. A combining method of the left-eye image and the right-eye image (image format for a three-dimensional view) contains a frame packing method, a side-by-side method, and a top-and-bottom method etc., but any formats may be used as long as the method projects the left-eye image and the right-eye image in a time division. In the following description, the left-eye image and the left-eye frame image data will be referred to as an L image and L image data, and the right-eye image and the right-eye frame image data will be referred to as an R image and R image data.

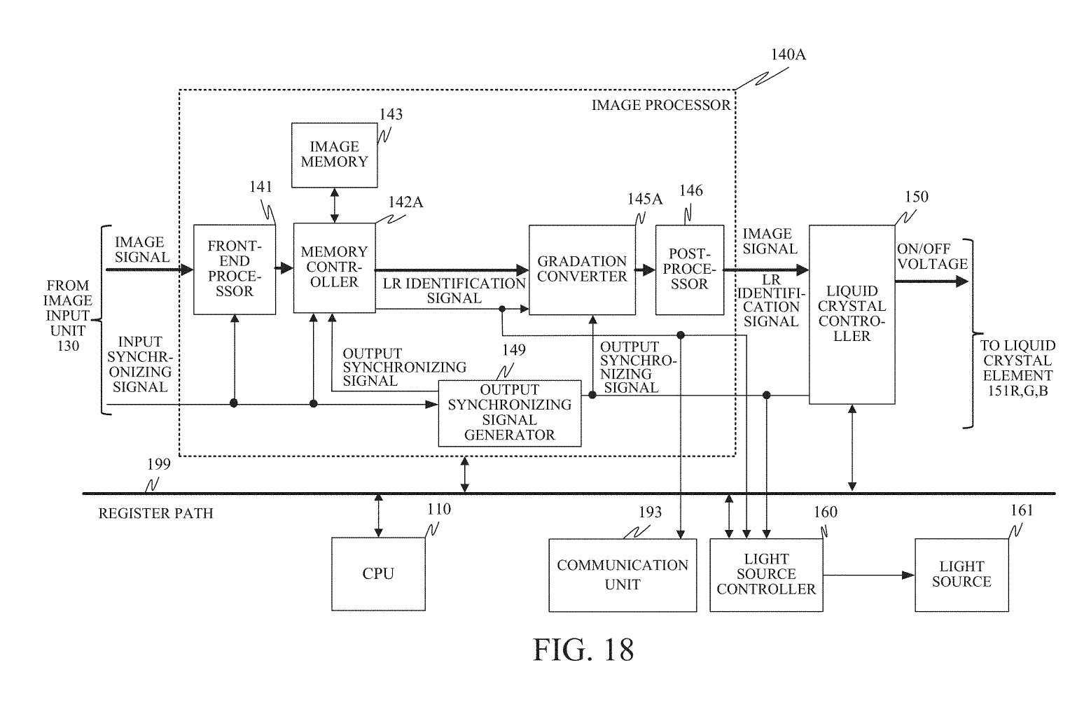

FIG. 18 illustrates an internal structure of an image processor 140A according to this embodiment. The image processor 140A includes a front-end processor 141, a memory controller 142A, an image memory 143, a gradation converter 145A, a postprocessor 146, and an output synchronizing signal generator 149. The front-end processor 141, the postprocessor 146, and the output synchronizing signal generator 149 operate similarly to those in the first embodiment.

The memory controller 142A reads the L image data and R image data from the image memory 143 in a reading order in accordance with the previously input image format for the three-dimensional view and outputs the data to the gradation converter 145A so as to alternately output the L image data and the R image data. For example, the memory controller 142A initially reads the L image data for the first frame from the image memory 143 and outputs it to the gradation converter 145A, and then reads the R image data for the first frame from the image memory 143 and outputs it to the gradation converter 145A. Thereafter, the memory controller 142A similarly reads data from the image memory 143 and outputting it to the gradation converter 145A in order of the L image data and R image data for the second frame, the L image data and R image data for the third frame, etc. Then, the memory controller 142A outputs an LR identification signal used to identify one of the L image data and the R image data which is to be output, to the gradation converter 145A, the light source controller 160, and the communication unit 193. The communication unit 193 sends this LR identification signal to unillustrated glasses for a three-dimensional view mounted on the observer.

The glasses for the three-dimensional view enable the observer to visually recognize the projected image corresponding to the L image data only with the left eye by opening the left-eye shutter and by closing the right-eye shutter, when the received LR identification signal represents the L image data. The glasses for the three-dimensional view enable the observer to visually recognize the projected image corresponding to the R image data only with the right eye by opening the right-eye shutter and by closing the left-eye shutter, when the received LR identification signal represents the R image data. Thereby, the observer can view the three-dimensional image.

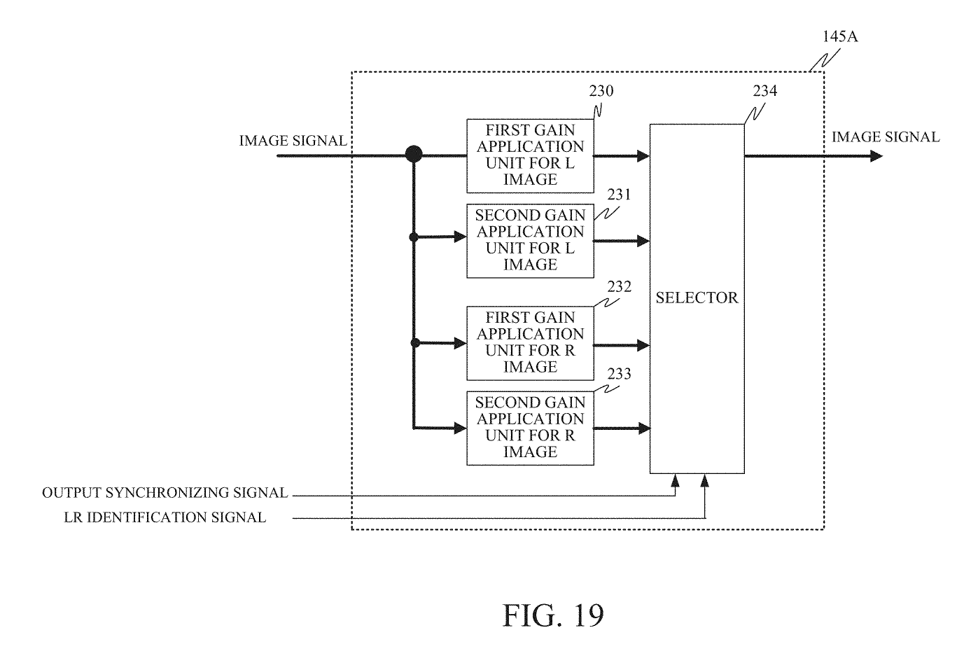

The gradation converter 145A provides the gradation conversion processing based on the input LR identification signal. FIG. 19 illustrates the internal structure of the gradation converter 145A. The gradation converter 145A includes an L-image first gain application unit 230, an L-image second gain application unit 231, an R-image first gain application unit 232, an R-image second gain application unit 233, and a selector 234. The L-image first gain application unit 230 applies a predetermined gain to the L image data for the first frame (by multiplying the gain coefficient). Similarly, each of the L-image second gain application unit 231, the R-image first gain application unit 232, and the R-image second gain application unit 233 applies a predetermined gain to the L image data for the second frame, the R image data for the first frame, and the R image data for the second frame. A multiplier may apply a gain to the gradation converter 145A, and the gain application may be performed through reading of the gradation value after the gain application with the LUT

The selector 234 switches the output image signal (between the L image data and the R image data) in accordance with the output synchronizing signal and the LR identification signal. In other words, when the LR identification signal represents the L image data with odd frames, such as the first frame, the L image data is output after the gain application by the L-image first gain application unit 230. When the LR identification signal represents the R image data, the R image data is output after the gain application by the R-image first gain application unit 232. When the LR identification signal represents the L image data with even frames, such as the second frame, the L image data is output after the gain application by the L-image second gain application unit 231. When the LR identification signal represents the R image data, the R image data is output after the gain application by the R-image second gain application unit 233. The L image data and the R image data after the gain application (gradation conversion processing) sequentially output from the selector 234 are sequentially input to the liquid crystal controller 150, and the voltage on/off of the liquid crystal element 151 is controlled based on the L image data and R image data.

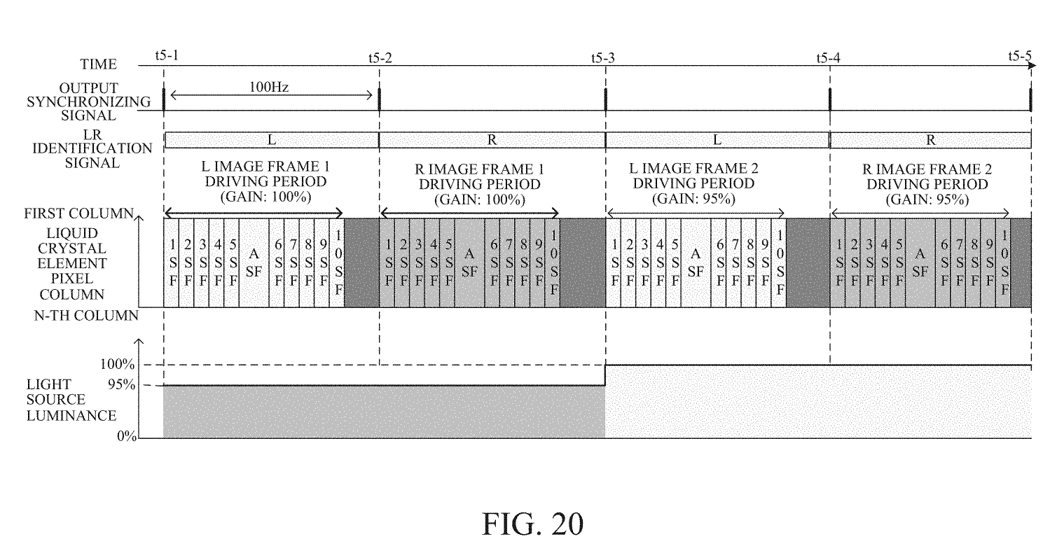

FIG. 20 illustrates the voltage on/off updating timing in the liquid crystal element 151 and the luminance changing timing in the light source 161 according to this embodiment. Each of the L-image first gain application unit 230 and the L-image second gain application unit 231 applies, as the predetermined gains, gains of 100% and 95% to the L image data. Each of the R-image first gain application unit 232 and the R-image second gain application unit 233 applies, as the predetermined gains, gains of 100% and 95% to the R image data. The liquid crystal element 151 displays the L image data and R image data for each frame by updating the voltage on/off of all pixels from 1SF to 10SF.

The image processor 140A (selector 234) alternately outputs the L image data and R image data, and FIG. 20 illustrates a timing relationship between the output synchronizing signal and the LR identification signal. In other words, the LR identification signal in periods from time t5-1 to time t5-2 and from time t5-3 to time t5-4 in which the L image data is output is a signal representing the L image data. Similarly, the LR identification signal in periods from time t5-2 to time t5-3 and from time t5-4 to time t5-5 in which the R image data is output is a signal representing the R image data.

The liquid crystal element 151 displays the L image data in the L-image driving period for the frame 1 and the L-image driving period for the frame 2 to which the gains 100% and 95% are applied respectively, and subsequent odd and even frames are treated similarly. This configuration can change a dark line position caused by the disclination in the projected image corresponding to the L image data for the odd and even frames, and enable the left eye of the observer to less visually recognize the pixel brightness drop caused by the disclination. The liquid crystal element 151 displays the R image data in the R-image driving period for the frame 1 and the R-image driving period for the frame 2 to which the gains 100% and 95% are applied respectively, and subsequent odd and even frames are treated similarly. This configuration can change a dark line position caused by the disclination in the projected image corresponding to the R image data for the odd and even frames, and enable the right eye of the observer to less visually recognize the pixel brightness drop caused by the disclination.

As described above, the gradation converter 145A provides different gradation conversion processing for the L image data and R image data to be alternately output. Thereby, in projecting an image for a three-dimensional view, the left eye and right eye of the observer can less visually recognize the brightness drop caused by the disclination.

On the other hand, the light source controller 160 changes the luminance in the light source 161 in accordance with the output synchronizing signal and the LR identification signal so as to reduce the luminance change in the projected image that is caused by the different gradation conversion processing for each frame. In other words, when the liquid crystal element 151 displays the L image data after the gain of 100% is applied, the light source controller 160 sets the luminance in the light source 161 to 95%. When the liquid crystal element 151 displays the R image data after the gain of 95% is applied, the light source controller 160 sets the luminance in the light source 161 to 100%. Hence, the brightness in the projected image corresponding to the L image data and R image data is maintained as constant as 95%. Therefore, when an image signal with a low frame rate is input, this configuration can restrain the flickers caused by the gradation conversion processing that makes the disclination hard to be visually recognized.

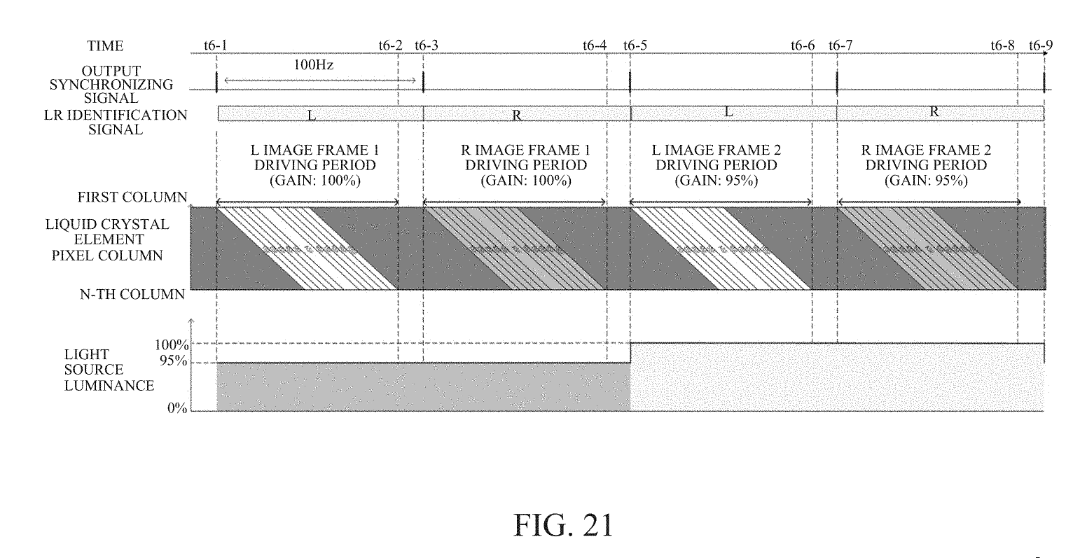

As described above, the voltage on/off of the liquid crystal element 151 is updated by the all-pixel updating method. On the other hand, FIG. 21 illustrates the voltage on/off updating timing and the luminance changing timing in the light source 161 when the scan updating method described in the second embodiment updates the voltage on/off of the liquid crystal element 151. The scan updating method controls the luminance of the light source controller 160 similarly to all-pixel updating method. Thereby, in projecting an image for a three-dimensional view, the left and right eyes of the observer are less likely to visually recognize the pixel brightness drop caused by the disclination.

The above first to third embodiments change the luminance in the light source 161. However, an element that can change a light intensity may be provided between the light source 161 and the liquid crystal element 151 without changing the luminance in the light source 161 may change the intensity of the illumination light incident on the liquid crystal element 151.

### Fourth Embodiment

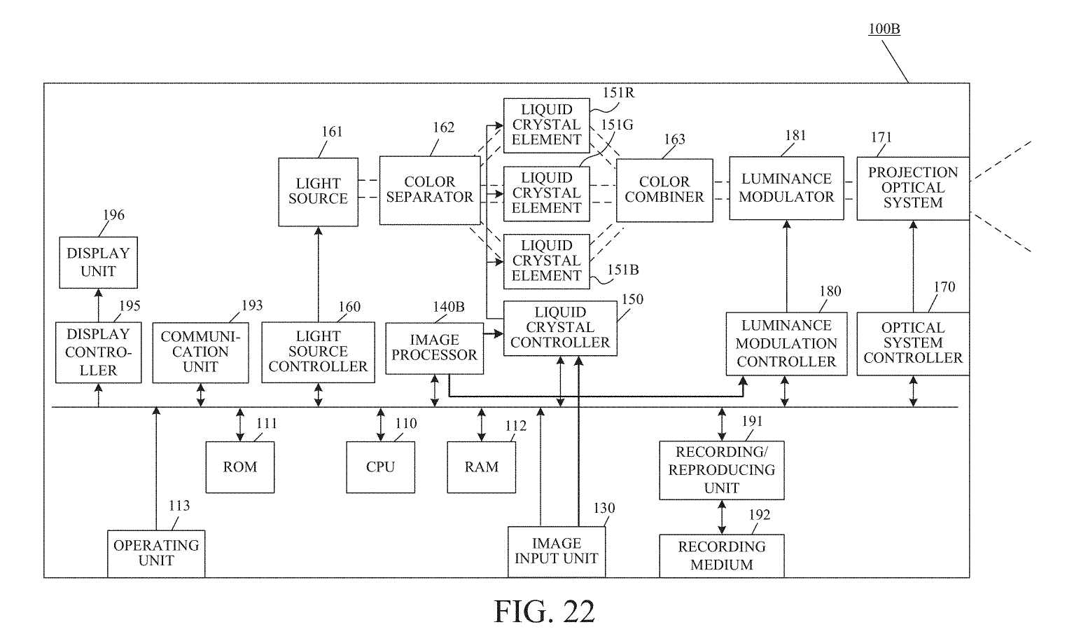

Next follows a description of a liquid crystal projector according to a fourth embodiment of the present invention. FIG. 22 illuminates the structure of a liquid crystal projector 100B according to this embodiment. Those elements in FIG. 22, which are corresponding elements in FIG. 1, will be designated by the same reference numerals, and a description will be omitted.

A luminance modulation controller 180 controls a luminance modulation element 181 as a light intensity changer that can change an intensity of combined light (display light) of red light, green light, and blue light from the color combiner 163 in accordance with an output signal from the image processor 140B. In other words, the luminance modulation controller 180 controls the light intensity. The CPU 110 and the luminance modulation controller 180 constitute a controller.

The luminance modulation element 181 has the same number of pixels as that of the liquid crystal element 151 and can individually change the reflectance or transmittance of each pixel. Each pixel in the luminance modulation element 181 corresponds to each pixel in the liquid crystal element 151. The combined light having the luminance modulated by the luminance modulation element 181 is projected onto a target plane via the projection optical system 171.

The luminance modulation element 181 may be an element using liquid crystal or a digital micro mirror (DMD). A detailed description will be given of a control of the luminance modulation element 181 by the luminance modulation controller 180.

A recording/reproducing unit 191 reproduces still image data and motion image data from a recording medium (storage) 192. The recording/reproducing unit 191 may record still image data and motion image data received from a communication unit 193 in the recording medium 192. The recording/reproducing unit 191 includes, for example, an interface electrically connected to the recording medium 192, and a microprocessor that communicates with the recording medium 192. The recording/reproducing unit 191 may not include a dedicated microprocessor, and the CPU 110 may serve similarly to the recording/reproducing unit 191 in accordance with a program stored in the ROM 111, for example. The recording medium 192 can record still image data, motion image data, and control data necessary for a liquid crystal projector according to this embodiment, and may include a magnetic disk, an optical disc, a semiconductor memory, and any other types of recording media. The recording medium 192 may be attached to and detached from the liquid crystal projector or of a built-in type.

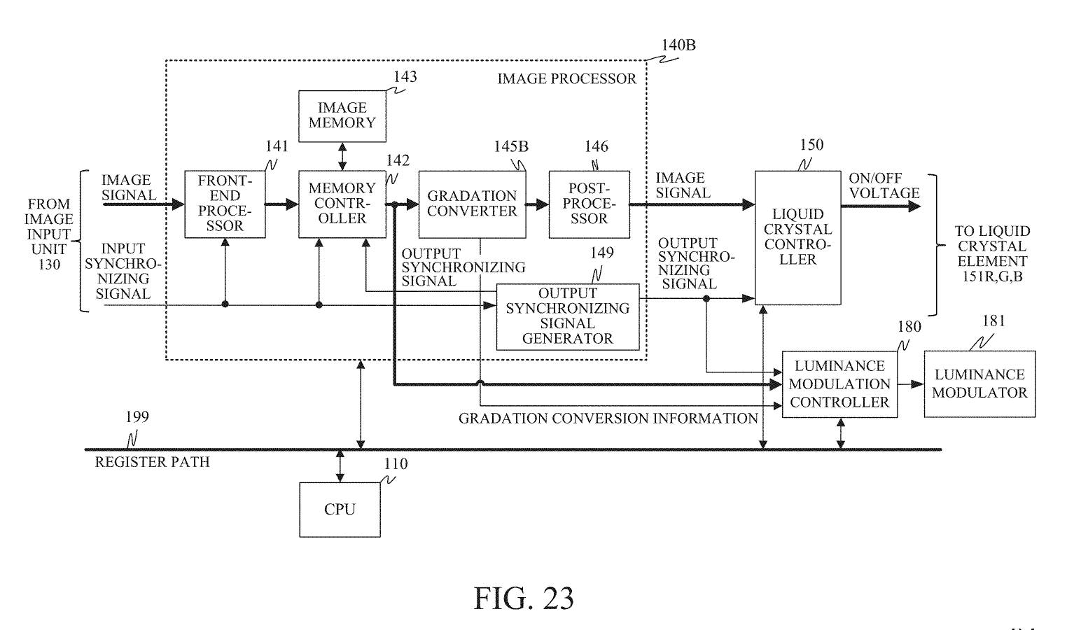

FIG. 23 illustrates an internal structure of the image processor 140B. The image processor 140B has the internal structure similar to that of the image processor 140 illustrated in FIG. 11 according to the first embodiment, and those elements corresponding to those in the image processor 140 will be designated by the same designated by the same reference numerals and a description thereof will be omitted. According to this embodiment, the memory controller 142 outputs image data read out of the image memory 143 to the luminance modulation controller 180. The structure of the gradation modulator 145B is different from that of the gradation converter 145 according to the first embodiment.

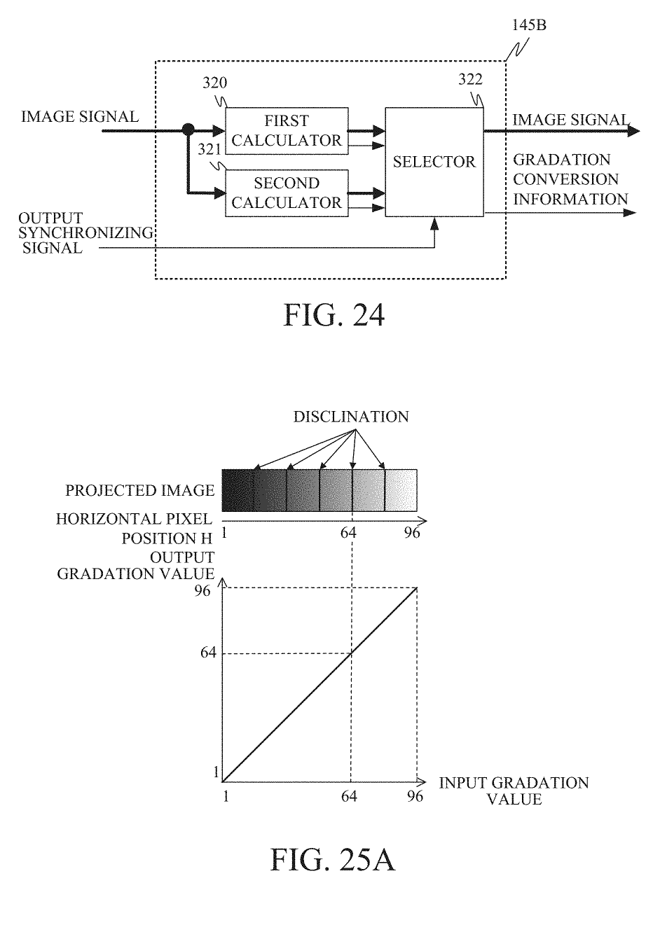

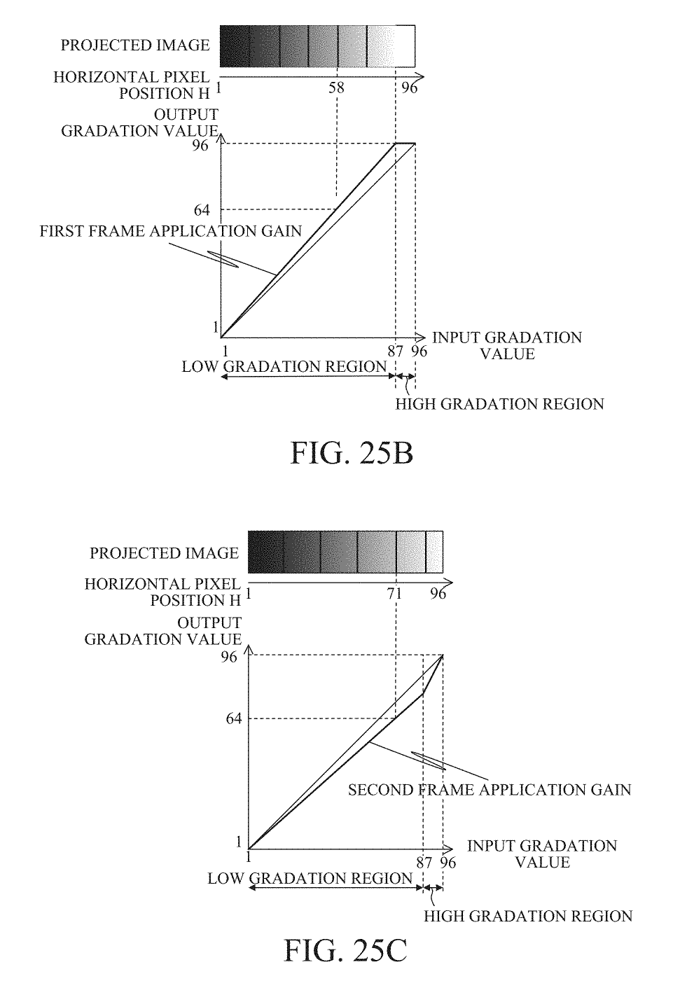

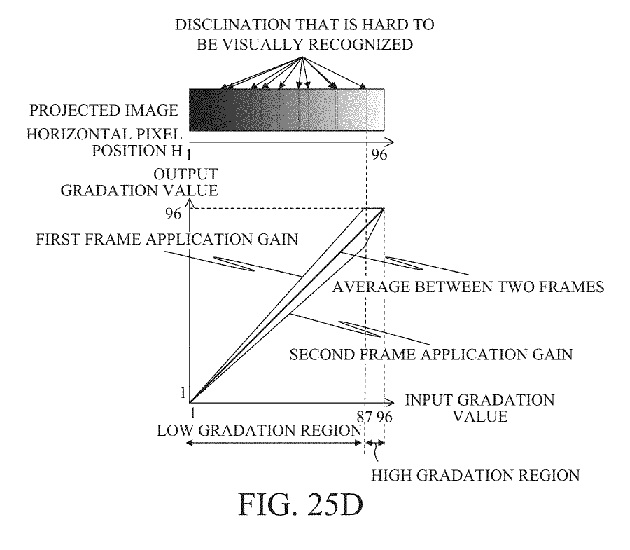

FIG. 24 illustrates the structure of the gradation converter 145B according to this embodiment. The gradation converter 145B includes a first calculator 320, a second calculator 321, and a selector 322. Each of the first calculator 320 and the second calculator 321 applies a different gain to input image data (or performs gain processing as different gradation conversion processing), and outputs image data (image signal) after the gain application. The selector 322 alternately switches and outputs image data from the first calculator 320 and the second calculator 321 in synchronization with the output synchronizing signal. The gradation converter 145B outputs image data to which a different gain is applied for each frame, and makes the brightness drop by the disclination hard to be visually recognized. Referring now to FIGS. 25A to 25D, a description will be given of this principle.

FIG. 25A illustrates a relationship (I/O gradation characteristic) between the input gradation value and the output gradation value and a projected image visually recognized by the observer when the gradation converter 145B provides no gain control process or the gain coefficient (gain coefficient) is 100%. The liquid crystal element 151 according to this embodiment has 96 pixels in the horizontal direction. In displaying the gradation image in which the gradation simply increases one by one in the right direction, assume that five dark lines caused by the disclination are recognized as illustrated in FIG. 25A.

In this embodiment, the gain processing performed by the first calculator 320 and the second calculator 321 is expressed as follows. In the following expression, X is an input gradation value, Y1 is an output gradation value from the first calculator 320, and Y2 is an output gradation value from the second calculator 321. Ymax is a maximum value of the output gradation value, and A is a gain coefficient which the first calculator 320 applies to the input gradation value or multiplies the input gradation value by.

| | |
|---|---|
| Y1 = AX | (X < Ymax/A) |
| Y1 = Ymax | (X ≥ Ymax/A) |
| Y2 = (2-A)X | (X < Ymax/A) |
| Y2 = 2X-Ymax | (X ≥ Ymax/A) |

In the above expression, A may have an arbitrary value as long as it satisfies 1<A≤2. This embodiment sets A to 1.1 (110%). Where A=1.1 (110%), FIG. 25B illustrates an I/O gradation characteristic of the first calculator 320 and FIG. 25C illustrates an I/O gradation characteristic of the second calculator 321.

Now address the disclinations at the adjacent positions with the input gradation values 64 and 65. Referring now to FIG. 25B, a description will be given of a change of the disclination position when the first calculator 320 performs gain processing for the gradation image similar to the above one. The gain process with the gain coefficient of 110% performed by the first calculator 320 moves the adjacent relationship between the gradation values 64 and 65 to the pixels at the positions 58 and 59. Hence, the dark line caused by the disclination occurs in the pixel located at the position 58 that displays the gradation value 64.

Referring now to FIG. 25C, a description will be given of a change of the disclination position when the second calculator 321 performs gain processing. The gain processing with the gain coefficient of 90% performed by the second calculator 321 moves the adjacent relationship between the gradation values 64 and 65 to the pixels at the positions 71 and 72. Hence, the dark line caused by the disclination occurs in the pixel located at the position 71 that displays the gradation value 64.

Since the gradation converter 145B alternately switches the calculation results of the first calculator 320 and the second calculator 321 for each frame, the projected image is alternately switched between the image illustrated in FIG. 25B and the image illustrated in FIG. 25C are for each frame. When this image switching period for these two frames is shorter than a predetermined value, the observer can visually recognize the averaged image between two frames and the dark lines caused by the disclination with an about ½ concentration as illustrated in FIG. 25D. Due to this principle, the operation of the gradation converter 145B can make the dark line caused by the disclination hard to be visually recognized. This principle is similarly applied to other disclination positions.

Next follows a description of a control of the luminance modulation element 181 by the luminance modulation controller 180. The luminance modulation controller 180 is connected to the CPU 110 via the register bus 199. The luminance modulation controller 180 controls the luminance modulation element 181 in accordance with the image data from the memory controller 142, the gradation conversion information from the gradation converter 145B, and the output synchronizing signal output from the output synchronizing signal generator 149.

The luminance modulation controller 180 controls the luminance modulation rate in the luminance modulation element 181 in synchronization with the driving period for the liquid crystal element 151. Assume that a first frame is a frame for which the first calculator 320 in the gradation modulator 145B outputs the gain-processed gain data, and a second frame is a frame for which the second calculator 321 outputs the gain-processed gain data.

Assume that L1 is a luminance modulation rate of the luminance modulation element 181 when the liquid crystal element 151 displays the image data for the first frame, and L2 is a luminance modulation rate of the luminance modulation element 181 when the liquid crystal element 151 displays the image data for the second frame. Then, the luminance modulation controller 180 controls the luminance modulation element 181 as follows:

L1=(2−A)X/Y1

L2=(2−A)X/Y2

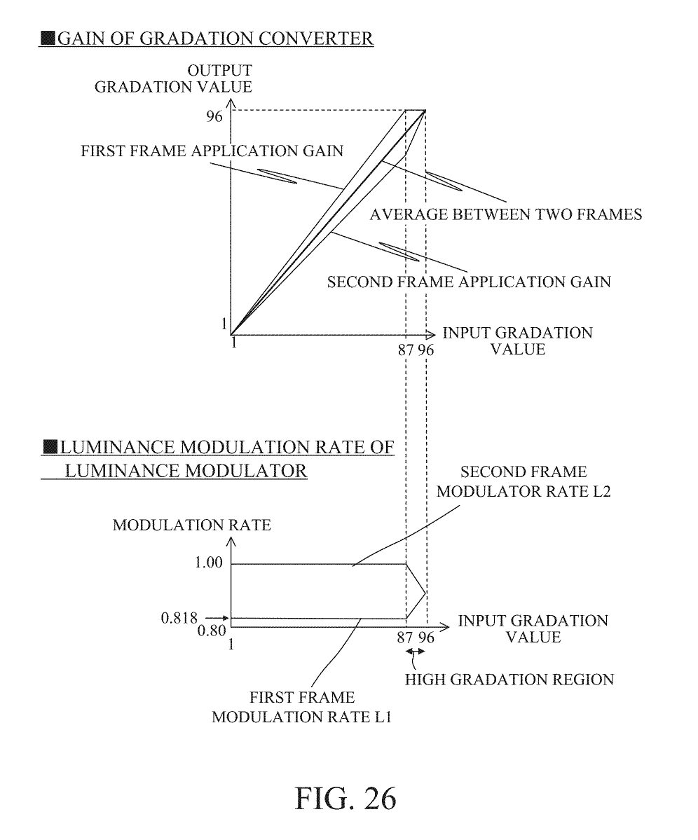

FIG. 26 illustrates the gain processing by the gradation converter 145B and the luminance modulation rate in the luminance modulation element 181 for the input gradation value when A is set to 1.1 (110%). As illustrated in FIG. 26, a finally input luminance in the first frame is a product between the output gradation values Y1 and L1 from the first calculator 320 by controlling the luminance modulation rate in the luminance modulation element 181. A finally input luminance in the second frame is a product between the output gradation values Y2 and L2 from the second calculator 321. Hence, the output luminance for each frame is made constant or (2−A) times as large as the input gradation value X irrespective of the frame.

According to this embodiment, since the gain coefficient A which the first calculator 320 applies to the low gradation side is 1.1 (110%), the luminance modulation controller 180 controls the luminance modulation element 181 so that the output luminance is 90% of the input gradation value in each frame. The luminance modulation controller 180 controls the luminance modulation rate in the luminance modulation element 181 so as to reduce (cancel) the gradation change in the liquid crystal element 151 caused by the different gradation conversion processing for each frame by the gradation converter 145B or the luminance change in the projected image. When an image signal with a low frame rate is input, this configuration can restrain the flickers associated with the gradation conversion processing that makes the disclination hard to be visually recognized.

In driving the liquid crystal element 151 through the scan updating method described in the second embodiment, this embodiment drives all pixels in the same frame in the liquid crystal element 151 in a period shorter than a change period of the illuminance modulation rate (display light intensity) of the luminance modulation element 181. This configuration can prevent the gradation deterioration caused by the change of the luminance modulation rate of the luminance modulation element 181 in the driving period of the same frame.

The structure of the gradation converter 145B is not limited to that illustrated in FIG. 24, and may be that described with reference to FIGS. 12A to 12C in the first embodiment. A description till be given of the luminance modulation rate of the luminance modulation element 181 in the offset processing that adds and subtracts the predetermined value to and from the input gradation value similar to the structure illustrated in FIG. 12B. Assume that B(X) is a predetermined value (a function of X) added or subtracted in each frame to or from the input gradation value X. Then, the output gradation values Y1 and Y2 from the gradation converter 145B are defined as follows.

Y1=X+B(X)

Y2=X−B(X)

In this case, the luminance modulation controller 180 sets the luminance modulation rates L1 and L2 in the luminance modulation element 181 as follows.

L1=(X−B(X))/Y1

L2=(X−B(X))/Y2

This control of the luminance modulation rate in the luminance modulation element 181 sets the finally output luminance to (X−B(X)) that is constant irrespective of the frame. Thus, the luminance modulation controller 180 provides a control so as to reduce the luminance change in the projected image caused by the gradation conversion processing that is different for each frame by the gradation converter 145B. When an image with a low frame rate is input, this configuration can restrain the flickers caused by the gradation conversion processing that makes the disclination hard to be visually recognized.

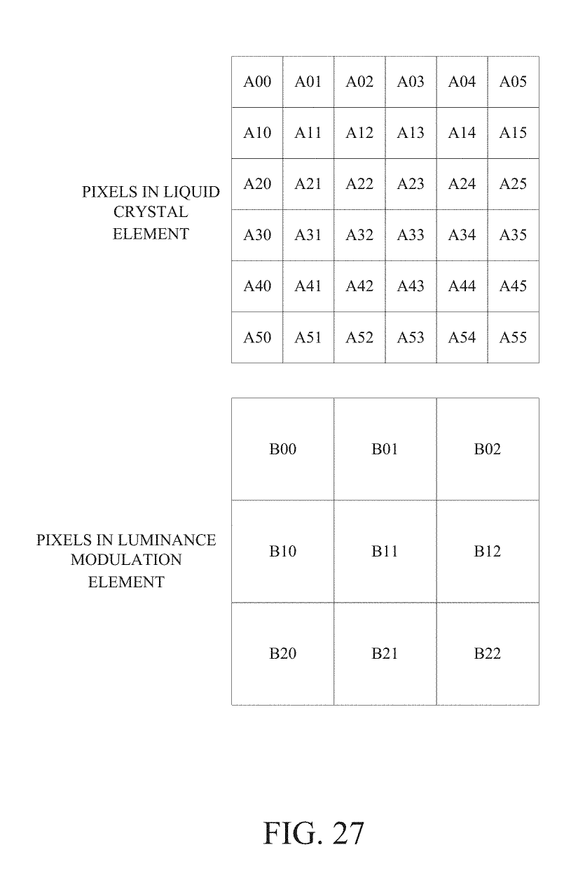

This embodiment supposes the luminance modulation element 181 and the liquid crystal element 151 have the same resolutions (the same number of pixels), but the luminance modulation element 181 and the liquid crystal element 151 may have different resolutions. For example, as illustrated in FIG. 27, when the resolution of the luminance modulation element 181 is half of the resolution of the liquid crystal element 151, light made by modulating four pixels A00, A01, A10, and A11 in the liquid crystal element 151 is again modulated by one pixel B00 in the luminance modulation element 181. Similarly, light modulated by other four pixels in the liquid crystal element 151 is again modulated by another pixel in the luminance modulation element 181. In this case, when the four pixels (pixel area) in the liquid crystal element 151 that emits light to be modulated by each pixel in the luminance modulation element 181 contain input gradation values in the high gradation region, the gradation deteriorates and the flickers may occur. For example, when the input gradation value corresponds to a low gradation region or X<Ymax/A, the output gradation values Y1 and Y2 from the gradation converter 145B are as follows.

Y1=AX

Y2=(2−A)X

At this time, the luminance modulation rates L1 and L2 in the luminance modulation element 181 for the first frame 1 and the second frame 2 are uniquely determined irrespective of the input gradation value X as follows.

L1=(2−A)X/Y1=(2−A)X/AX=(2−A)/A

L2=(2−A)X/Y2=(2−A)X/(2−A)X=1

However, when the input gradation value is X≥Ymax/A, the output gradation values Y1 and Y2 from the gradation converter 145B are as follows.

Y1=Ymax

Y2=2X−Ymax

At this time, the luminance modulation rates L1 and L2 in the luminance modulation element 181 for the first frame 1 and the second frame 2 are as follows, and it is necessary to change them according to the input gradation value X.

L1=(2−A)X/Y1=(2−A)X/Ymax

L2=(2−A)X/Y2=(2−A)X/(2X−Ymax)

In other words, when the modulation rates L1 and L2 in the luminance modulation element 181 are set to specific pixels in the liquid crystal element 151, the gradation deteriorates in the pixel area that contains the specific pixels. Moreover, the flickers may be generated in the pixel area by the gradation conversion processing in the gradation converter 145B and the controlled luminance modulation rate in the luminance modulation controller 180.

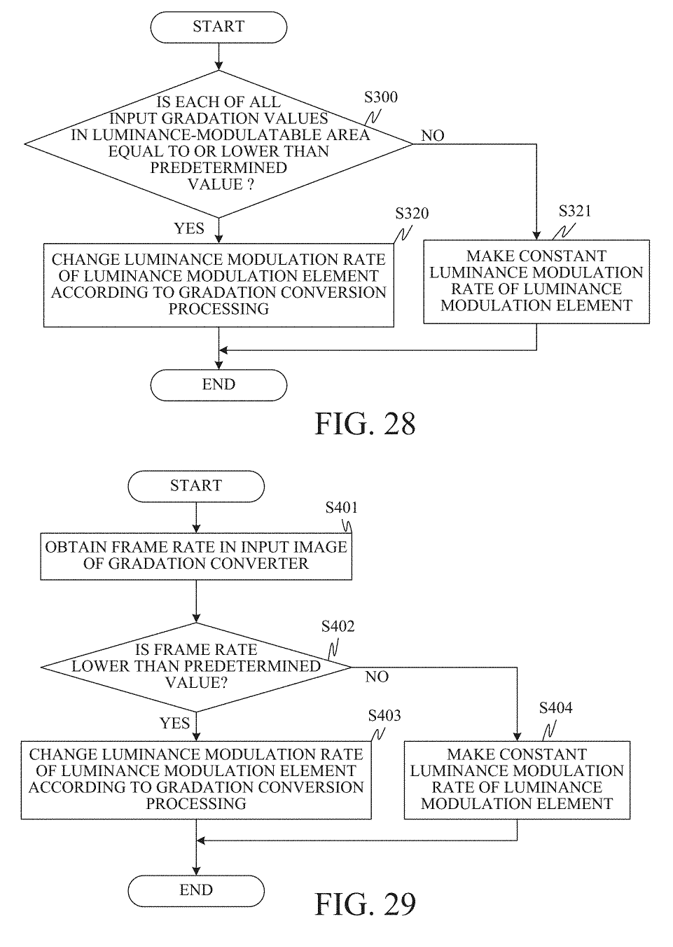

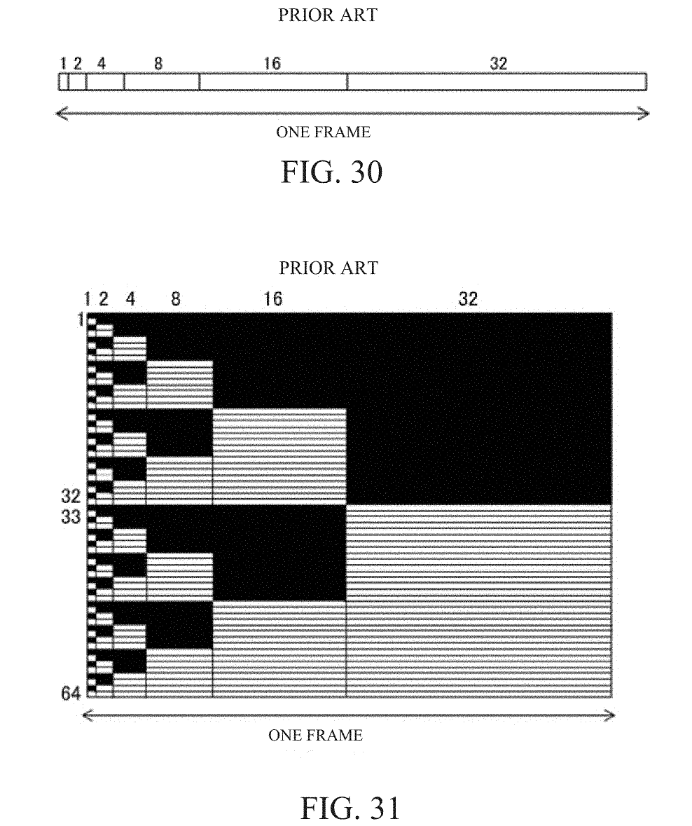

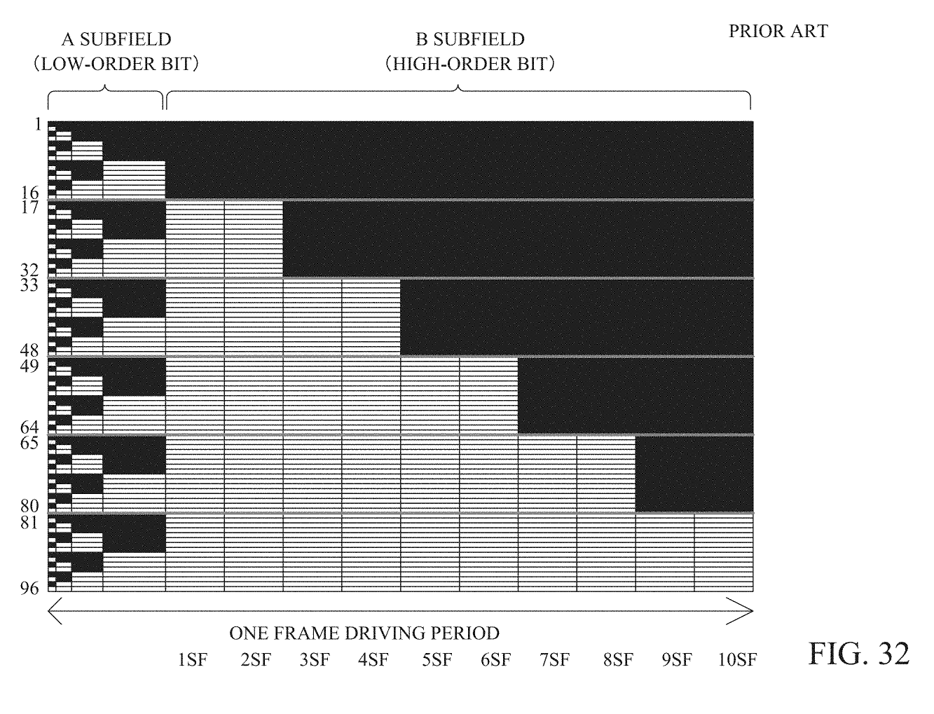

According to this embodiment, the luminance modulation controller 180 controls the light intensity as illustrated in a flowchart in FIG. 28 so as to maintain the gradation quality in the pixel area. The luminance modulation controller 180 controls the light intensity in accordance with the luminance modulation program as a liquid crystal display program or a computer program.

Initially, in the step S300, the luminance modulation controller 180 determines whether an input gradation value before all gradation conversion processing to four pixels contained in the pixel area in the liquid crystal element 151 corresponding to each pixel in the luminance modulation element 181 is equal to or smaller than a predetermined value. The predetermined value is an input gradation value corresponding to a gain change point after the gradation conversion processing by the gradation converter 145B. Since the gradation converter 145B according to this embodiment can provide different gradation conversion processing using the input gradation value of 90% as a threshold, 90% of the maximum input gradation value is set to the predetermined value. In other words, in the step S300, the luminance modulation controller 180 determines whether all input gradation values in the four pixels corresponding to pixels in the luminance modulation element 181 are equal to or smaller than 90% of the maximum input gradation value. The luminance modulation controller 180 moves to the step S301 when all input gradation values in the four pixels are equal to or smaller than 90% of the maximum input gradation value, and moves to the step S302 when at least one of the input gradation values in the four pixels is larger than 90% of the maximum input gradation value.

In the step S301, the luminance modulation controller 180 controls the luminance modulation rate in the luminance modulation element 181 in accordance with the gradation conversion processing by the gradation converter 145B as described above so as to reduce the flickers.

In the step S302, the luminance modulation controller 180 provides a control such that the luminance modulation rate can be constant or the predetermined value in the pixels in the luminance modulation element 181 corresponding to the four pixels in the liquid crystal element 151.

According to this embodiment, when all input gradation values in the pixel area (four pixels) in the liquid crystal element 151 are located on the low gradation side, the finally output luminance is 90% of the input gradation value due to the process in the step S301. Therefore, the gradations of both pixel areas can be maintained by setting the output luminance to 90% of the input gradation value in the pixel area in which the input gradation value is located on the high gradation side. When the step S302 maintains the luminance modulation rate in the luminance modulation element 181 as constant as 90%, the output luminance in the pixel area in which the input gradation value is located on the high gradation side can be set to 90% of the input gradation value through averaging the two frames.

The luminance modulation controller 180 performs the above processing for all pixels in the luminance modulation element 181. When the luminance modulation controller 180 operates as described above, the gradation quality can be maintained in the entire projected image. When the step S302 maintains constant as the predetermined value the luminance modulation rate in the luminance modulation element 181, the pixels may cause the flickers through the different gradation conversion processing for each frame by the gradation converter 145B. However, a flicker amount is smaller than that with the prior art that causes the flickers on the entire projected image.

As illustrated in the flowchart in FIG. 29, the CPU 110 may determine whether the luminance modulation rate in the luminance modulation element 181 is to be changed in accordance with the change period of the gradation conversion processing by the gradation process in the gradation converter 145B. The CPU 110 and the luminance modulation controller 180 execute the following processes in accordance with the liquid crystal display program.

In S401, the CPU 110 as the measurement unit calculates a frame rate of the input image data input to the gradation converter 145B. This frame rate is calculated based on the frame rate of the image signal input to the image input unit 130 and the conversion ratio in the frame rate conversion processing performed by the memory controller 142. For example, in processing that inputs the image signal of 50 Hz to the image input unit 130 and doubles the frame rate in the memory 142, the frame rate in the input image data input to the gradation converter 145B is expressed by 50 Hz×double-speed=100 Hz. This is calculated based on the frame rate input to the image input unit 130 and the frame rate conversion processing performed by the memory controller 142. For example, in processing that inputs the image signal of 50 Hz to the image input unit 130 and converts the frame rate in the memory 142, the frame rate of the image input to the gradation converter 145B is expressed by 50 Hz×double-speed=100 Hz.

In S402, the CPU 110 determines whether the frame rate calculated in S401 is lower than a predetermined value, and moves to S403 when the frame rate is lower than the predetermined value. On the other hand, when the calculated frame rate is equal to or higher than the predetermined value, the flow moves to S404. The predetermined value is an upper limit value of the frame rate, such as 120 Hz, at which the observer can easily visually recognize the luminance change of the projected image caused by the gradation conversion processing that is different for each frame performed by the gradation conversion process 145B. When the frame rate is 120 Hz or higher, the observer has difficulties in visually recognizing the luminance change in the projected image caused by the gain processing that is different for each frame. It is unnecessary to change the luminance modulation rate in the luminance modulation element 181 for each frame.

In S403, the CPU 110 instructs the luminance modulation controller 180 to change the luminance modulation rate in the luminance modulation element 181 in synchronization with the change of the gradation conversion processing by the gradation converter 145B as described with reference to FIG. 26. This configuration can restrain the flickers along the gradation conversion processing that makes the disclination hard to be visually recognized, as described above.

On the other hand, in S404, the CPU 110 instructs the luminance modulation controller 180 to control the luminance modulation rate in the luminance modulation element 181 so as to maintain it constant (100%). This configuration can prevent the unnecessary brightness drop in the projected image at the frame rate at which the flickers are less likely to be visually recognized, with the gradation conversion processing that makes the disclination hard to be visually recognized.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-097775, filed on May 17, 2017, which is hereby incorporated by reference herein in its entirety.

What is claimed is:

1. A liquid crystal display apparatus configured to introduce illumination light from a light source to a liquid crystal element and to display an image, the liquid crystal display apparatus comprising:
a gradation converter configured to generate a plurality of subframes by performing different gradation conversion processing for a plurality of input frames that are continuously input;
a driver configured to drive the liquid crystal element by controlling an application period of a first voltage and an application period of a second voltage lower than the first voltage for each pixel in the liquid crystal element in accordance with gradation data for each subframe; and
a controller configured to provide a light intensity control for each subframe so as to change an intensity of the illumination light or an intensity of display light from the liquid crystal element in accordance with the gradation conversion processing for generating the subframe.

2. The liquid crystal display apparatus according to claim 1, wherein the controller provides the light intensity control so as to reduce a luminance change in a display image for each subframe which is caused by the different gradation conversion processing.

3. The liquid crystal display apparatus according to claim 1, wherein the controller changes a luminance in the light source in the light intensity control.

4. The liquid crystal display apparatus according to claim 1, further comprising a light intensity changer configured to change the intensity of the display light for each pixel or each pixel area that contains one or more pixels in the liquid crystal element,
wherein the controller controls the light intensity changer through the light intensity control.

5. The liquid crystal display apparatus according to claim 4, wherein the light intensity changer includes an element that can change a transmittance or a reflectance for the display light, and
wherein the controller changes the transmittance or the reflectance of the light intensity changer through the light intensity control.

6. The liquid crystal display apparatus according to claim 4, wherein the controller sets whether the light intensity control is to be provided for each pixel area.

7. The liquid crystal display apparatus according to claim 1, wherein the gradation converter applies gains different from each other for the plurality of input frames in the different gradation conversion processing.

8. The liquid crystal display apparatus according to claim 1, wherein the gradation converter adds a value to or subtracts the value from each of the plurality of input frames in the different gradation conversion processing.

9. The liquid crystal display apparatus according to claim 1, wherein the gradation converter includes a plurality of gradation conversion data tables corresponding to drive gradation values that are different from each other for gradation values in the input frames, and uses the gradation conversion data tables that are different from each other in the different gradation conversion processing.

10. The liquid crystal display apparatus according to claim 1, further comprising a measurement unit configured to measure a frame rate in input image data that contains a plurality of input frames,
wherein the controller provides the light intensity control when the measured frame rate is lower than a predetermined value.

11. The liquid crystal display apparatus according to claim 1, wherein the driver sequentially drives each pixel in part of the liquid crystal element based on the subframes in displaying the image based on one subframe, and
wherein the driver drives all pixels in the liquid crystal element in the subframes in a period shorter than a change period of the intensity of the illumination light or the display light.

12. The liquid crystal display apparatus according to claim 1, wherein the gradation changer provides the different gradation conversion processing to each of a plurality of left eye frame image data and a plurality of right eye frame image data input to the plurality of input frames.

13. A liquid crystal display method configured to introduce illumination light from a light source to a liquid crystal element and to display an image, the liquid crystal display method comprising the steps of:
generating a plurality of subframes by performing different gradation conversion processing for a plurality of input frames that are continuously input;
driving the liquid crystal element by controlling an application period of a first voltage and an application period of a second voltage lower than the first voltage for each pixel in the liquid crystal element in accordance with gradation data for each subframe; and
providing a light intensity control for each subframe so as to change an intensity of the illumination light or an intensity of display light from the liquid crystal element in accordance with the gradation conversion processing for generating the subframe.

14. A storage medium storing a program that enables a computer to execute a liquid crystal display method that introduces illumination light from a light source to a liquid crystal element, displays an image, and includes the steps of:
generating a plurality of subframes by performing different gradation conversion processing for a plurality of input frames that are continuously input;
driving the liquid crystal element by controlling an application period of a first voltage and an application period of a second voltage lower than the first voltage for each pixel in the liquid crystal element in accordance with gradation data for each subframe; and
providing a light intensity control for each subframe so as to change an intensity of the illumination light or an intensity of display light from the liquid crystal element in accordance with the gradation conversion processing for generating the subframe.

15. A liquid crystal display apparatus configured to display an image based on an input frame, comprising:
a light source;
a modulator configured to modulate illumination light from the light source with a liquid crystal element and to display the image;
a generator configured to generate a first frame and a second frame through different gradation conversion processing performed for each input frame;
a first controller configured to control an application period for a first voltage and an application period for a second voltage lower than the first voltage to each pixel in the liquid crystal element, in a period for displaying the image based on each input frame; and
a second controller configured to control an intensity of the light source in the period for displaying the image based on each frame,
wherein the first controller controls the liquid crystal element so as to display an image based on the first frame and an image based on the second frame in this order; and
wherein the second controller controls the light source so that the intensity of the light source in the period for displaying the image based on the first frame is different from the intensity of the light source in the period for displaying the image based on the second frame.

16. The liquid crystal display apparatus according to claim 15, wherein the generator generates the first frame by applying a first gain to gradation data of the input frame and generates the second frame by applying a second gain smaller than the first gain to the gradation data of the input frame, and
wherein the second controller controls the intensity of the light source so that the light intensity in the light source in a period for displaying the image based on the first frame is smaller than that in a period for displaying the image based on the second frame.

17. The liquid crystal display apparatus according to claim 15, wherein the first controller controls the liquid crystal element so as to alternately display the image based on the first frame and the image based on the second frame.

18. The liquid crystal display apparatus according to claim 15, wherein the modulator is a projection unit configured to modulate the illumination light from the light source and to project the image onto a projection surface.
